(19) United States
(12) Patent Application Publication
(10) Pub. No.: US 2026/0111200 A1
(43) Pub. Date: Apr. 23, 2026

(54) METHOD AND SYSTEMS FOR CONVERTING FLOWCHART TO CODE USING CONTEXT-AWARE GENERATIVE ARTIFICIAL INTELLIGENCE

(71) Applicant: AIRA TECHNOLOGIES, INC., Saratoga, CA (US)

(72) Inventors: Ravikiran GOPALAN, SARATOGA, CA (US); Rahul VIPPALA, SARATOGA, CA (US); Jash RATHOD, San Jose, CA (US)

(21) Appl. No.: 19/364,327

(22) Filed: Oct. 21, 2025

Related U.S. Application Data
(60) Provisional application No. 63/710,419, filed on Oct. 22, 2024.
(60) Provisional application No. 63/754,861, filed on Feb. 6, 2025.

(51) Int. Cl. G06F 8/41; G06F 8/35; G06F 8/61; G06F 11/3604; G06F 11/3668; G06F 11/3698; G06F 16/901

(52) U.S. Cl. CPC G06F 8/447; G06F 8/35; G06F 8/63; G06F 11/3612; G06F 11/3684; G06F 11/3688; G06F 11/3698; G06F 16/9024

(57) ABSTRACT

Systems and methods transform a user-defined program flowchart into executable code. A graphical authoring/import interface persists the flowchart as a typed graph of nodes and edges. A knowledge base is built by ingesting user-authorized schemas, code repositories, and API specifications, normalizing discovered elements as term objects with types and aliases. For nodes containing natural-language or pseudocode text, a domain-specific selection model, constrained to the knowledge base, selects canonical domain terms. The typed graph and selections are lowered to an intermediate representation and compiled into target-specific code including parameterized data-access statements and API invocations. The system synthesizes and executes unit and path tests, then assembles a deployable runtime package with a configuration manifest identifying dependencies, secrets, endpoints, and health probes. The package may be deployed as an rApp in a Service Management and Orchestration environment to analyze RAN KPIs and issue closed-loop control actions.

### CROSS-REFERENCE TO RELEVANT APPLICATION

This application claims the benefit of priority under 35 U.S. C. § 119(e) to U.S. Provisional Patent Application No. 63/710,419, entitled “Method And System For Converting Flowchart To Code Using Context-Aware Generative Pre-Trained Transformer,” filed on Oct. 22, 2024, and U.S. Provisional Patent Application No. 63/754,861, entitled “Method And System For Improved AI-Assisted RAN Algorithm Synthesis And Code Generation (Flow2code),” filed Feb. 6, 2025, the entire contents of which are hereby incorporated by reference in their entirety.

### TECHNICAL FIELD

The present disclosure relates to software development technologies and, more particularly, to systems and methods that transform user-created flowcharts and natural-language objectives into tested, deployable applications (e.g., executables, binaries). In particular, this disclosure covers automated life-cycle management including knowledge-base-constrained code generation, ambiguity resolution, unit-test synthesis, and packaging for execution in target environments such as cloud or container platforms and, in some embodiments, Radio Access Network (RAN) management environments.

### BACKGROUND

Implementing executable logic has traditionally required skilled programmers fluent in languages, tools, and deployment practices. This reliance on specialists creates a barrier for domain experts who understand the process they want to automate but lack the time or training to translate that process into working code. The problem is acute in operational domains—such as telecommunications networks—where workflows evolve quickly and must integrate with domain-specific data sources and runtime systems.

Conventional life-cycle management (LCM) often follows a linear, document-driven model: design artifacts and specifications are handed off to developers, code is produced, and testing occurs only after integration. Manual handoffs, disconnected tools, and the absence of a common, machine-checkable representation slow delivery and make defects harder to detect early.

Visual programming tools attempt to lower the barrier by letting users draw logic with blocks for conditions, loops, and actions. These systems, however, typically rely on rigid, prewired mappings from shapes to code and require users to know exact variable names and APIs. They do not interpret multi-objective natural-language instructions, cannot resolve ambiguities when a user term maps to multiple domain meanings or none at all, and rarely generate self-tests or produce a package that is ready to deploy in a real environment.

The gap is widest when logic must reference domain-specific identifiers—existing code repositories, database tables and columns, API endpoints, message fields, units, and constraints—that vary across organizations. Mapping a flowchart's “subject” (described in natural language) or pseudocode variables to those canonical identifiers, and verifying type and units compatibility, is labor-intensive and error-prone without a domain knowledge base and automated selection mechanisms.

There is therefore a need for integrated systems that let users describe objectives in natural language within a flowchart, automatically map those descriptions to canonical domain terms drawn from user-authorized schemas, code repositories, and API specifications, synthesize unit and path tests from a typed representation of the flow, and package the result as a deployable artifact. In some embodiments, the same pipeline supports practical applications in RAN operations by ingesting performance data and enabling closed-loop control, while remaining applicable to other domains and deployment targets.

### SUMMARY

This disclosure describes a comprehensive GenAI-powered platform or system that allows users to create or import flowcharts, convert them into executable code, automate unit testing, and deploy the code into an rApp. Users can design flowcharts using the built-in graphical interface or import them from external applications, such as CSV files or other types of files. The platform interprets flowchart components and associated descriptions to generate code using domain-specific terms. It also automatically generates unit tests to validate the functionality of the generated code and facilitates deployment within a RAN network environment. In some embodiments, the system includes at least the following components and functionalities.

### Flowchart Creation and Importation

The system may operate on a program flowchart that defines executable control and data flow for an application. A flowchart may be produced with a built-in authoring tool or imported from an external source. In either case, the system may persist (e.g., store) the flow as a typed graph in non-transitory storage, with nodes representing operations (e.g., start/end, condition, loop, and execution/process blocks) and directed edges representing control transfer, optionally annotated with predicates and data bindings. At least a subset of nodes may carry a node description comprising natural-language text or pseudocode that expresses the user's objective without requiring domain-specific identifiers; these descriptions may later drive mapping to canonical terms in the knowledge base and subsequent code generation.

In some embodiments, the built-in authoring tool may present an intuitive graphical canvas with a finite set of predefined shapes, each corresponding to specific coding logic. A condition block may include one inlet and two outlets that denote “true” and “false” paths; a loop block may include an entry inlet and a back-edge outlet; an execution/process block may denote an action with one or more data inputs and outputs; and start/end blocks may indicate flow initiation and termination. Shapes may have predefined inlets and outlets to ensure logical consistency when connected. When a user selects a node or edge, a properties panel may allow setting the node type and label and entering objectives in natural language. The editor may enforce well-formedness in real time—for example, constraining decision nodes to Boolean-typed branches and preventing dangling connectors—and may serialize the authoritative typed graph for downstream processing.

In some embodiments, the system may construct an equivalent internal graph from external artifacts. For tabular sources, a CSV reader may accept a canonical schema including columns such as “id,” “type,” “label,” “next,” “cond_true,” and “cond_false,” validate identifier uniqueness, and synthesize terminal nodes where successors are absent. For JSON-based diagram formats (e.g., Excalidraw), an importer may map shape types and connectors to node and edge records and normalize labels while preserving quoted literals. For raster images (e.g., PNG or JPEG), an optional vision pipeline may apply primitive detection and OCR to recover rectangles, diamonds, ovals, and arrows and infer edge direction from arrowheads. In each case, the resulting structure may be persisted as the typed graph with node descriptions intact so that later stages can use the natural-language objectives to select domain terms and generate executable code.

### Incorporation of Descriptive Language and Pseudocode

Within each flowchart component, a user may enter one or more objectives in natural language or pseudocode that describe the intended behavior of that component without supplying domain-specific identifiers. As the text is entered, the system may normalize it into a standardized phrase and an embedding and may attach those artifacts to the node record of the typed graph together with any inferred constraints such as expected input/output types. These descriptions may later drive retrieval from the knowledge base and selection of canonical domain terms while preserving the user's wording for traceability.

In some embodiments, the flowchart editing tool of the system may provide inline assistance while the user types, including suggested domain terms that satisfy typed-graph constraints, warnings when a description is ambiguous or incompatible with adjacent ports, and links that open a clarification panel. The user may accept a suggestion or supply a clarification in place; accepted choices may be cached and reused across nodes that share the same phrase.

### Context-Aware Data Management System

The system may include a context-aware data management system that constructs and maintains a knowledge base of domain terms from user-authorized sources such as database schemas, code repositories, interface specifications, and domain rules. Ingested elements may be normalized as term objects with canonical names, aliases, type descriptors (including formats, units, and nullability), lineage, and governance tags. The knowledge base may be indexed both lexically and semantically (e.g., with vector embeddings) and versioned so that mappings and generated artifacts can be reproduced against a specific schema snapshot.

### Code Generation Process (Visual and Natural-Language Encoders)

In some embodiments, the process of converting flowcharts into executable code involves several steps. First, a domain-specific model (e.g., a multi-modal processing unit, such as a neural network) may process both the visual structure of the flowchart and the node-level text. A visual encoder (e.g., a Convolutional Neural Network) may represent the flowchart as a graph that captures node kinds, control edges, and data-flow ports. A natural-language encoder may parse the node objectives, resolve references and synonyms, and produce features that condition subsequent retrieval and selection. The encoders'outputs may be consumed by a retriever to form a candidate set of domain terms and by a selection model to choose one or more canonical terms under constraints imposed by the typed graph and knowledge base.

Next, when the system detects that a phrase in the node objectives or references/synonyms (of a node in the flowchart or graph) maps to multiple domain terms, to no term, or conflicts with typed-graph constraints, the system may utilize a UI to highlight the offending token and open an interactive control such as a drop-down listing the top-K candidates. A user's selection may update the binding for the current node and may be propagated to other nodes that use the same phrase. The clarification may be recorded with a schema-version identifier and, in some embodiments, used as supervised data to fine-tune the selection model.

Then, each flowchart block (including one or more nodes and associated edges) may be translated into a discrete code unit (e.g., a function or method) whose inputs, outputs, and side effects are determined by the bound domain terms and the node kind. Condition blocks may be rendered as if/else constructs, looping blocks as for/while structures with initialization and termination conditions, and execution blocks as parameterized API calls or data-access statements. Connections in the flowchart may be compiled into call sites and control structures; a symbol table or shared context may carry values between producer and consumer blocks. The code units may be lowered through a typed intermediate representation and stitched into a cohesive program that preserves the control and data dependencies of the original graph.

### Automated Unit Testing

For each generated code unit, the system may synthesize unit and path tests that target block semantics and inter-block paths. Decision nodes may yield tests for alternative outcomes; looping nodes may yield edge and interior cases; execution blocks may yield correctness checks against mocked services or provisioned fixtures. Coverage metrics may be computed, and progression to packaging may be gated on thresholds declared in a configuration manifest. When the flowchart changes, affected tests may be re-synthesized and a regression suite may be executed automatically.

### Deployable Application Packaging

After successful testing, the system may assemble a deployable package that includes the emitted code and a configuration manifest identifying dependency versions, environment variables, logical secrets, network endpoints, and health/metrics probes. The package may target containers, binaries, or web runtimes and, in some embodiments, may be produced as an rApp bundle suitable for execution in a Service Management and Orchestration environment.

### Advantages of the Invention

The system offers several advantages, including efficiency by automating multiple stages of software development, reducing time and effort. It enhances accessibility by enabling users without deep programming knowledge to develop applications using flowcharts and natural language. The system provides customization by tailoring code generation to specific domains through learning from user-provided databases and repositories. It ensures scalability, being applicable to various domains and adaptable to different programming languages and frameworks. Moreover, it maintains consistency by ensuring that generated code follows domain-specific standards and conventions.

### BRIEF DESCRIPTION OF THE DRAWINGS

FIG. 1 shows a comparison between existing software life cycle management (LCM) and the GenAI-based System described in this application.

FIG. 2 is an example system-level block diagram of a flowchart-to-code (also called Flow2Code) system, in accordance with some embodiments.

FIG. 3 is an example flow diagram of an end-to-end method implemented by the system to transform a user's flowchart or prompt into deployable code, in accordance with some embodiments.

FIG. 4A illustrates an example graphical authoring interface that may allow a user to construct and define a flowchart, in accordance with some embodiments.

FIG. 4B illustrates an example split-view interface in which the user-defined flowchart may remain visible on the left while a code view on the right may display target-specific code generated from the typed graph and the bound domain terms.

FIG. 5 illustrates an example test interface that may present results of automatically generated unit and path tests, in accordance with some embodiments.

FIG. 6 illustrates a system diagram of a context-aware data management system supporting the system, in accordance with some embodiments.

FIG. 7 illustrates the fine-tuning process and deployment of the domain-specific LLM in the context-aware data management system, as part of the supporting the system, in accordance with some embodiments.

FIG. 8 illustrates an example flowchart describing a dynamic network management process in telecommunications for optimizing wireless connectivity in high-density environments such as stadiums, in accordance with some embodiments.

FIG. 9 illustrates example node objectives in the flowchart of FIG. 8, in accordance with some embodiments.

FIG. 10 illustrates an example computing system that may be used in implementing various features of embodiments of the disclosed technology.

### DETAILED DESCRIPTION

The following detailed description introduces a flowchart-to-code (also called Flow2Code) system that compiles a program flowchart and node-level natural-language descriptions into deployable, domain-correct code by constraining generative inference with an organization-specific knowledge base and a typed compilation pipeline. In contrast to conventional “code-from-diagram” approaches, the disclosed system grounds every generated identifier and operation in schemas, APIs, and repositories that the user has authorized the system to ingest, and it verifies those choices through static typing and schema guards before any code can execute.

In some embodiments, the system is implemented as instructions stored on non-transitory machine-readable media and executed by one or more hardware processors coupled to a display, input devices, and a network interface. The system maintains a canonical, typed graph representation of a user's flowchart, where nodes represent actions, decisions, inputs/outputs, and start/end markers, and directed edges encode control transfer and optional predicates. Users may author this graph in a built-in editor or import it from external sources; in either case the graph is persisted with stable identifiers, versioning, and provenance so that any generated artifact can be traced back to its originating nodes.

To translate human-readable node text into domain-specific code, the system constructs and maintains a knowledge base populated from user-authorized backends (for example, database catalogs, API specifications, and code repositories). During ingestion the system enumerates tables, columns, types, constraints, function signatures, message schemas, and documented aliases, and normalizes them into term objects (data objects) that are indexed for both lexical and semantic retrieval. This organization-specific knowledge base acts as a boundary for code generation: candidate identifiers proposed during code generation must be found in, and be type-compatible with, the active schema version.

A domain-specific language-model component is then employed as a constrained mapper rather than an unconstrained author. Given the flowchart's node text or pseudocode, the mapper proposes one or more canonical terms from the knowledge base, but its output is filtered by a schema guard that enforces type, units, and access-policy compatibility. Accepted mappings are recorded with their provenance (input phrase, chosen term, schema version, and model build) in an append-only audit log. By limiting the model to choosing among attested terms and by validating those choices deterministically, the system materially reduces ambiguity and prevents hallucinated identifiers from entering the build.

Then the mapped nodes are lowered into a typed intermediate representation (IR) that captures expressions, side effects, and control flow in static single assignment form. Target-specific backends render the IR into executable artifacts such as parameterized SQL with prepared statements, Python modules that call registered APIs, and configuration needed to run those artifacts in the intended environment.

Before deployment, the system creates and synthesizes tests from the control-flow graph and schema domains. For instance, decision nodes yield test inputs for both branches and boundary values; external dependencies are isolated behind generated mocks or provisioned into a sandbox with resource quotas. The system computes coverage metrics and enforces configurable gates; failures trigger localized fix suggestions that a user may accept. Static analyzers and data-flow sanitizers run in the same pipeline to check dependency integrity, PII propagation, and injection resistance.

For production use, the system packages the artifacts and their pinned dependencies into reproducible images and emits manifests that declare required permissions, secrets, and health probes. As used herein, a “configuration manifest” refers to a machine-readable artifact that describes how the emitted code is executed in a target environment, including at least dependency identifiers and versions, required environment variables and configuration values, logical references to secrets, network endpoints and health/metrics probes, resource limits, and rollout or policy settings. The manifest may be stored as a standalone file such as JSON or YAML, embedded as metadata within a deployable image, or persisted in a project database; all such forms are contemplated.

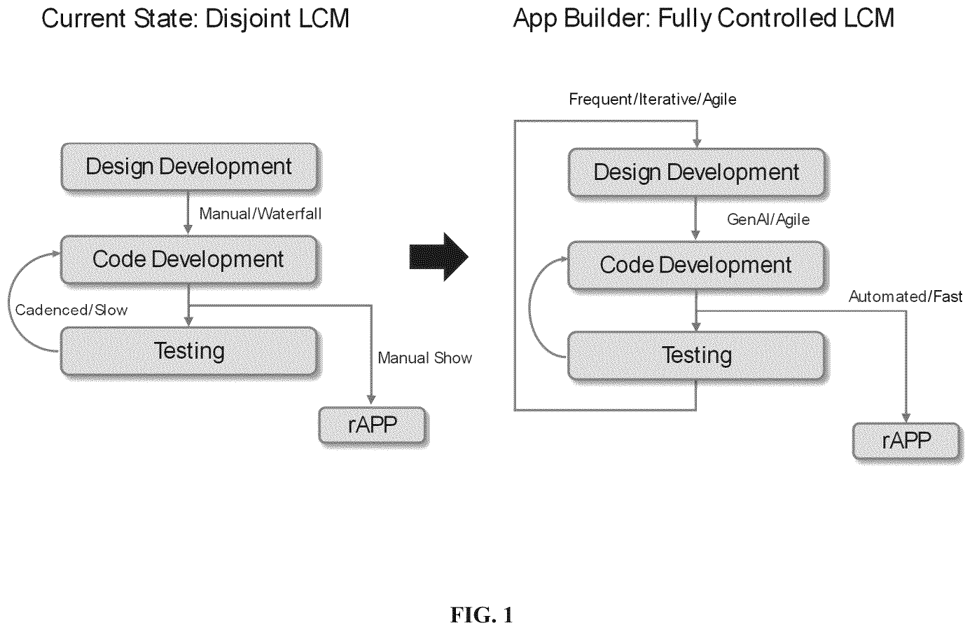

FIG. 1 shows a comparison between existing software life cycle management (LCM) and the GenAI-based System described in this application. The figure illustrates process flow and cadence at a high level rather than specific data structures or algorithms. The high-level difference lies in how System employs GenAI to speed up and automate code development and testing, transforming the slow, manual process into an agile, automated cycle. This creates more frequent, iterative improvements and faster rApp deployments.

On the left, “Current State: Disjoint LCM” shows a linear sequence in which “Design Development” hands off to “Code Development,” which then proceeds to “Testing,” followed by deployment to an rApp. The arrows indicate manual handoffs and a slower, cadenced progression with limited feedback from later stages back into earlier stages.

On the right, “System: Fully Controlled LCM” shows a unified loop in which “Design Development,” “Code Development,” and “Testing” occur more frequently and iteratively, with GenAI-assisted coding and increased automation. The arrows indicate tighter feedback and a faster path to packaging and deployment (e.g., to an rApp) compared to the disjoint workflow.

The figure does not depict internal mechanisms, which will be described in more details below. In some embodiments, the behaviors represented in the right-hand loop are realized using the components and methods described elsewhere, including the flowchart authoring/import and typed graph model, the explicit mapping of user-level terms to domain variables, planning and code generation, automated testing and gating, and deployment packaging. Other implementations that achieve the illustrated integrated loop may also be used.

As used herein, a “typed graph” or a “typed graph model” is a graph representation of the flowchart in which each node, edge, and connection point (port) carries machine-checkable type information and constraints, in contrast to an untyped graph that encodes connectivity only.

“Node kind” refers to the control-flow role of a flowchart node in the typed graph. It classifies what the node does structurally-such as START, END, PROCESS/EXECUTION, DECISION, LOOP, INPUT, or OUTPUT-independent of any domain variables or labels the user writes. The node kind determines required ports and valid edges (for example, a DECISION has one input and two outgoing branches, a START has no inputs), the expected result type on its outgoing control paths (for example, a DECISION produces a Boolean predicate), and the invariants the editor enforces.

The edges are tagged as control-flow or data-flow; data-flow ports are annotated with data types (e.g., boolean, integer, float, string, timestamp, array < . . . >) and optional refinements such as units (e.g., ms, %, dBm), nullability, and domain bounds. The system enforces well-formedness and type rules—e.g., DECISION nodes produce Boolean predicates feeding true/false control edges; joins require key type compatibility; arithmetic over string-typed values is rejected absent an explicit cast; and data-flow edges cannot terminate at control-only ports. A type inference pass propagates types through the graph from bound inputs (for example, a column typed as percentage) to downstream nodes, enabling early validation and deterministic lowering to a typed intermediate representation. This typed structure is what allows the system to generate parameterized queries and API calls with correct signatures, synthesize branch and boundary tests from declared domains, and prevent schema-incompatible identifiers from entering the build.

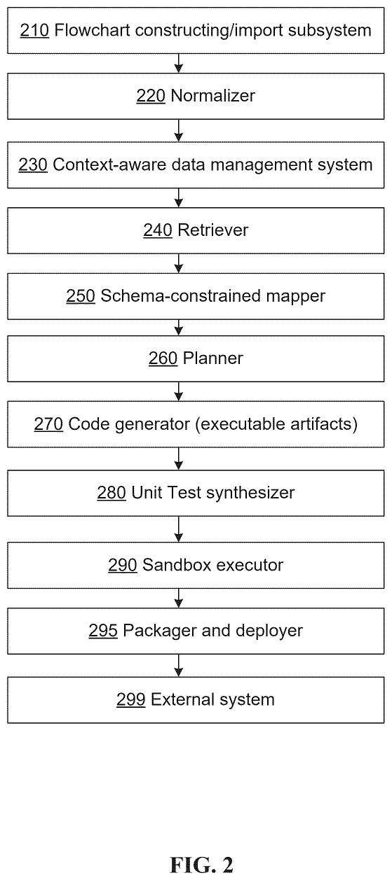

FIG. 2 illustrates an example system-level block diagram of a Flow2Code system, in accordance with some embodiments. The blocks in FIG. 2 illustrate functional components that may be executed by one or more hardware processors coupled to non-transitory machine-readable storage and a network interface. As shown, data may flow from a flowchart constructing/import subsystem 210 through a normalizer 220, into a context-aware data management system 230, and then through a retriever 240 and schema-constrained mapper 250 to a planner 260 and code generator 270. A unit-test synthesizer 280 and a sandbox executor 290 may validate generated artifacts before a packager and deployer 295 prepares outputs that interact with external systems 299.

In some embodiments, the flowchart constructing/import subsystem 210 may receive user input via a graphical authoring interface or import artifacts from external sources and may persist the flowchart as a typed graph of nodes and directed edges. In some embodiments, subsystem 210 supports native authoring on a canvas and import of structured files (for example, CSV or JSON diagram formats) and images that may be reconstructed into nodes and edges. The typed graph may distinguish control-flow from data-flow edges and may annotate data-flow ports with data types, units, and nullability.

In some embodiments, the normalizer 220 may standardize node-level natural-language or pseudocode descriptions into a machine-processable form. For example, the normalizer 220 may produce a normalized string and an embedding for each description and may attach these normalized artifacts to the corresponding node in the typed graph. In some embodiments, the normalizer 220 may also expand known aliases and preserve quoted literals. The normalized outputs of the normalizer 220 provide the inputs used by the retriever 240 when identifying domain terms corresponding to a node description.

In some embodiments, the context-aware data management system 230 may construct and maintain a knowledge base of domain terms by ingesting user-authorized sources with authenticated access. For example, the context-aware data management system 230 may enumerate database schemas, tables, columns, data types, constraints, and column descriptions; may parse code repositories to discover functions, classes, variables, and module paths together with inline documentation; and may parse API specifications to extract endpoint identifiers, parameters, and request/response field types. Retrieved elements may be normalized as term objects having canonical names, aliases, type descriptors (including formats, units, and nullability), and lineage. In some embodiments, the context-aware data management system 230 may index the term objects in both a lexical index and a vector-embedding index to support hybrid retrieval.

In some embodiments, the retriever 240 may, for a node that includes a description, query the indices maintained by the context-aware data management system 230 to identify a candidate set of domain terms responsive to the normalized string and/or embedding produced by the normalizer 220. In some embodiments, the retriever 240 may return the candidate set together with each candidate's type information so that subsequent stages can apply typed-graph constraints.

In some embodiments, the schema-constrained mapper 250 may select at least one canonical domain term from the candidate set and may bind that term to the node. In some embodiments, the schema-constrained mapper 250 may execute a fine-tuned domain-specific selection model conditioned on the normalized node description and on typed-graph context (for example, node kind and expected port types). The schema-constrained mapper 250 may further incorporate a schema guard that verifies that the selected term exists in the active knowledge base version and is type-compatible with constraints inferred from the typed graph.

In some embodiments, the planner 260 may lower the typed graph and the bindings into a typed intermediate program representation that encodes control flow and data dependencies. For example, the planner 260 may allocate basic blocks, compute dominator relationships, introduce φ-nodes at merge points, and propagate types derived from the knowledge base so that subsequent code generation occurs over well-typed operations.

In some embodiments, the code generator 270 may emit target-specific machine-executable artifacts from the intermediate representation. In some embodiments, the code generator 270 may generate parameterized data-access statements (e.g., SQL with prepared statements and explicit transaction scopes) and API client invocations resolved from interface specifications stored in the knowledge base. The generator may also produce a configuration manifest identifying dependency versions, environment variables, logical secret references, network endpoints, and health/metrics probes for the target environment.

In some embodiments, the unit-test synthesizer 280 may automatically generate tests based on the intermediate representation and knowledge-base types. For example, the unit-test synthesizer 280 may create tests that exercise alternative outcomes of decision nodes and boundary-value cases derived from declared domains, and may generate mocks or fixtures for external dependencies referenced by the emitted code. Outputs of the unit-test synthesizer 280 may be expressed in a standard test format and may be versioned with the corresponding flowchart revision.

In some embodiments, the sandbox executor 290 may execute the emitted code and the synthesized tests in an isolated runtime with resource limits such as CPU, memory, and wall-clock timeouts. In some embodiments, the sandbox executor 290 may include a runtime error handler that applies exception-specific correction rules and may re-run tests after patching. Results collected by the sandbox executor 290 may gate advancement to packaging and deployment.

In some embodiments, the packager and deployer 295 may assemble a deployable runtime package or image that includes the emitted code and configuration manifest. In some embodiments, the packager and deployer 295 may produce an Open Container Initiative-compliant image and may optionally create a domain-specific bundle (for example, an rApp deployable to a Service Management and Orchestration platform) that exposes health, metrics, or control endpoints. The packager and deployer 295 may initiate canary or blue/green rollout and monitor health probes and key performance indicators to trigger automatic rollback on regression.

In some embodiments, external systems 299 may represent services invoked by the emitted code at runtime. For example, external systems 299 may include relational databases, analytics services, or network-management controllers. In RAN embodiments, external systems 299 may further include interfaces used by service-management platforms to deliver performance-management data or to accept policy/configuration actions. Interactions with external systems 299 may be performed through the parameterized statements and API invocations generated by 270 and configured by the manifest produced by external systems 295.

Although FIG. 2 depicts the components in a particular order, other orders or combinations may be used. For example, 280 and 290 may be invoked iteratively with 270 to support regression testing after a user amends the flowchart, and 230 may update the knowledge base as new schemas or repositories are authorized, with 240-250 re-evaluating bindings accordingly.

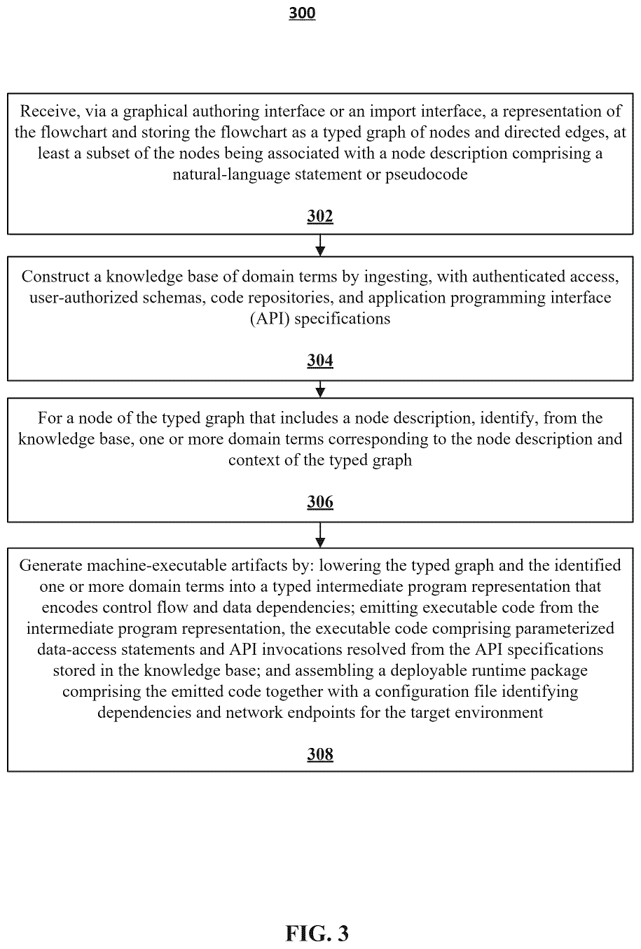

FIG. 3 illustrates an example flow diagram of an end-to-end method implemented by the system to transform a user's flowchart or prompt into deployable code, in accordance with some embodiments. The depicted blocks in FIG. 3 may be performed by a system with one or more hardware processors executing instructions stored in non-transitory memory. Arrows indicate a representative order of operations; in other embodiments, operations may be reordered, repeated, or performed in parallel as described below.

At block 302, the system may receive, via a graphical authoring interface or an import interface, a representation of a user-defined program flowchart and may persist the flowchart as a typed graph of nodes and directed edges. At least a subset of the nodes may be associated with a node description comprising natural-language text or pseudocode. The typed graph may distinguish control-flow from data-flow edges and may annotate data-flow ports with data types (and optionally units and nullability), thereby providing typed-graph context used in later operations.

In some embodiments, persisting the flowchart as a typed graph may include storing, for each node, a record with a stable identifier, a node kind selected from START, END, PROCESS, DECISION, INPUT, and OUTPUT, a set of input and output ports annotated with data types, units, and nullability, and a pointer to the node description. Each directed edge may reference a source port and a target port and may be tagged as control-flow or data-flow with an optional predicate. The graph may be serialized in a canonical form and validated to reject multiple START nodes, dangling connectors, and type-incompatible port connections.

At block 304, the system may construct a knowledge base of domain terms by ingesting, with authenticated access, user-authorized schemas, code repositories, and application-programming-interface (API) specifications. For example, the system may enumerate database schemas, tables, columns, data types, constraints, and column descriptions or acronyms; may parse repository source files to identify functions, classes, variables, and module paths together with inline documentation; and may parse API specifications to identify endpoint identifiers, parameters, and request/response field types. Retrieved elements may be normalized into term objects having canonical names, aliases, type descriptors (including formats, units, and nullability), and lineage, and may be indexed for retrieval.

In some embodiments, constructing the knowledge base may further include normalizing retrieved elements into term objects that each carry a canonical name, one or more aliases observed in the sources, a type descriptor including base type, unit, and nullability, and a lineage field that stores a SHA-256 digest of the source artifact. The system may assign monotonically increasing schema-version identifiers as ingestions commit, and may materialize both a lexical index for exact/fuzzy lookup and a vector-embedding index that supports approximate nearest-neighbor search, for example using a hierarchical navigable small-world graph. Governance tags such as access scope or PII classification may be stored per term object and consulted during later selection.

At block 306, for a node of the typed graph that includes a node description, the system may identify, from the knowledge base, one or more domain terms corresponding to the node description and the context of the typed graph. The identification may bind the node to at least one canonical domain term that appears in the knowledge base and is usable during code generation.

In some embodiments, the identification of block 306 may be realized as a two-stage procedure: the system may standardize the node description to produce a normalized string and an embedding, may perform a vector-based search over embeddings of domain terms stored in the knowledge base to form a candidate set, and may execute a fine-tuned, domain-specific neural network constrained to select only from that candidate set and conditioned on at least one of the normalized string, prior user interactions, or a user role to select the canonical domain term.

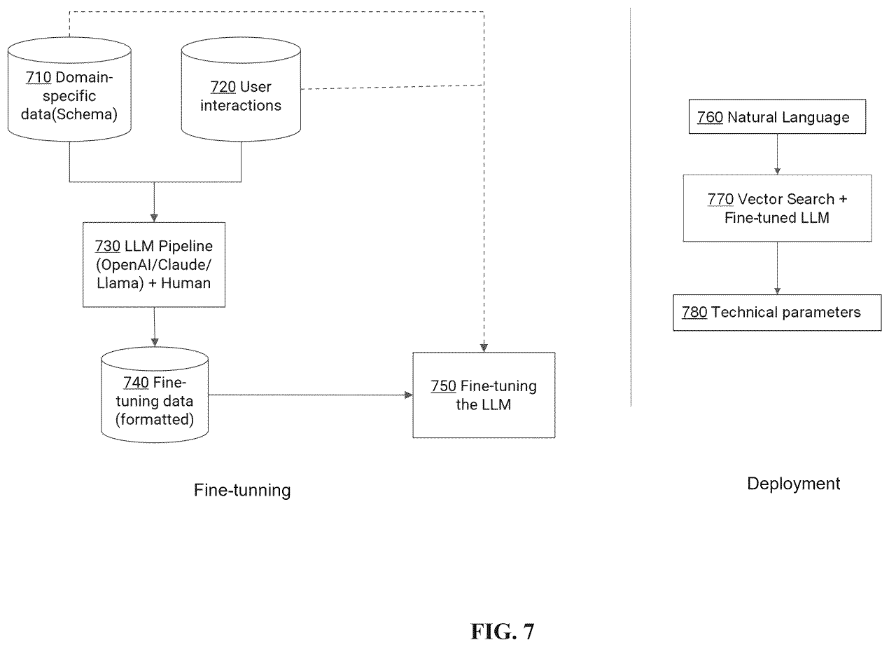

In some embodiments, the selection model of block 306 may be implemented as a neural network, for example a transformer-based language model fine-tuned to map node descriptions to canonical domain terms. The network may receive as inputs the normalized string and embedding produced by block 306, features of each candidate term (including aliases, type/units, and governance tags), and optional typed-graph context features (for example, node kind and expected port types). Constrained decoding may be implemented by masking the network's output vocabulary to identifiers of the candidate set so that the network selects only from candidates. The network may be fine-tuned using supervised pairs derived from domain data and validated user interactions as described with respect to FIG. 7, and may output a probability distribution over candidate identifiers from which a top-k or top-1 selection is made.

In some embodiments, the identification of block 306 may further apply typed-graph context by inferring constraints from the node and associated edges (such as node kind and expected data types of adjacent ports) and may bias selection toward candidates whose declared types satisfy the inferred constraints, thereby disfavoring candidates that are type-incompatible with the typed-graph context.

In some embodiments, identifying one or more domain terms may comprise computing a candidate set by querying the lexical and vector indices using the normalized string and embedding, and then ranking the candidates using a composite score S that may combine semantic similarity, type compatibility with constraints inferred from the typed graph, structural proximity in the schema, and project usage priors. A domain-specific selection model may then select one or more canonical domain terms from the top-ranked neighborhood under constrained decoding that limits output to identifiers present in the candidate set. Selections may be cached under the standardized phrase and schema-version key and recorded with model build identifiers for audit. In some embodiments, the composite score S may be combined with the neural network's softmax confidence to form a final selection score, and selections below a configurable threshold may trigger adjudication or fallback behavior.

At block 308, the system may generate machine-executable artifacts. In one implementation, block 308 may include sub-operations in which the system lowers the typed graph and the identified domain terms into a typed intermediate program representation that encodes control flow and data dependencies; emits target-specific executable code from the intermediate representation, the emitted code comprising parameterized data-access statements and API invocations resolved from interface specifications stored in the knowledge base; and assembles a deployable runtime package that includes the emitted code together with a configuration manifest identifying dependency versions and network endpoints for the target environment. The configuration manifest may also specify environment variables, logical secret references, health/metrics probes, and rollout settings.

In some embodiments, lowering to the typed intermediate representation into the typed intermediate program representation (encoding control flow and data dependencies) may include computing a dominator tree over the control-flow graph, inserting o-functions at dominance frontiers to form static single-assignment (SSA) form, and executing constant-propagation and dead-code-elimination passes to a fixed point. A φ-function (phi) is an SSA merge operator that, at a block with multiple predecessors, selects the appropriate incoming version of a variable based on the predecessor edge taken, thereby ensuring each variable has a single defining assignment.

In some embodiments, process 300 may further synthesize unit and path tests from the typed intermediate program representation and the knowledge-base types, may execute the tests, and may proceed with assembling or deploying the runtime package in response to determining that the tests pass. For example, the system may automatically generate tests that exercise alternative branches corresponding to different outcomes of decision nodes and may re-generate and re-run the tests after a modification of the flowchart.

In some embodiments, unit-test synthesis may enumerate paths through the control-flow graph to generate tests that exercise both outcomes of each DECISION node and may derive boundary-value inputs from the type domains recorded in the knowledge base. External calls identified in the intermediate representation may be isolated behind generated mocks or provisioned fixtures. Coverage metrics, including at least line and branch coverage, may be computed, and advancement to packaging may be gated on thresholds specified in the configuration manifest. When the flowchart is modified, the system may re-synthesize affected tests and re-execute a regression suite.

In some embodiments, the emitted code may be executed in a sandboxed runtime with resource limits, and, responsive to detecting a runtime error, a runtime error handler may modify the emitted code by applying exception-specific correction rules and may re-execute tests before packaging or deployment.

In some embodiments, the sandboxed runtime may execute the emitted code under CPU, memory, and wall-clock limits and may apply system-call filtering and network-policy restrictions. Upon detecting a runtime error, a runtime error handler may apply exception-specific correction rules, such as inserting casts when a type mismatch is detected against the knowledge-base schema or closing leaked handles, and may re-run the synthesized tests before permitting packaging or deployment.

In some embodiments in which the target environment comprises a Radio Access Network management environment, assembling the deployable runtime package may further include building a bundle deployable to a Service Management and Orchestration platform and exposing health, metrics, or control endpoints. Additional embodiments may include ingesting performance-management data, correlating the data with topology or inventory information, and executing the runtime package to detect conditions such as congestion, coverage or capacity imbalance, or energy-savings opportunities. Other embodiments may further issue closed-loop control actions via a policy interface between an orchestration component and a runtime controller, initiate configuration changes via a management interface targeting managed elements, and perform canary or blue/green deployment while monitoring health probes and key performance indicators to automatically roll back upon detecting a regression.

In some embodiments, assembling the deployable runtime package comprises generating environment-specific configuration files that declare one or more of dependency versions, environment variables, logical secret references, health and readiness probes, and metrics endpoints; building a container image that includes the emitted code; associating the environment-specific configuration files with the container image (for example, via a deployment descriptor or orchestrator binding); and outputting the deployable runtime package comprising the container image and the environment-specific configuration files.

Although FIG. 3 depicts some principal blocks 302, 304, 306, and 308, process 300 may include additional operations, fewer operations, different operations, or differently arranged operations than those shown. For example, identification at block 306 and generation at block 308 may be iterated as the knowledge base evolves or as the flowchart is edited; normalization and retrieval may be performed in parallel; and unit-test synthesis and sandbox execution may be interleaved with code emission to support regression workflows.

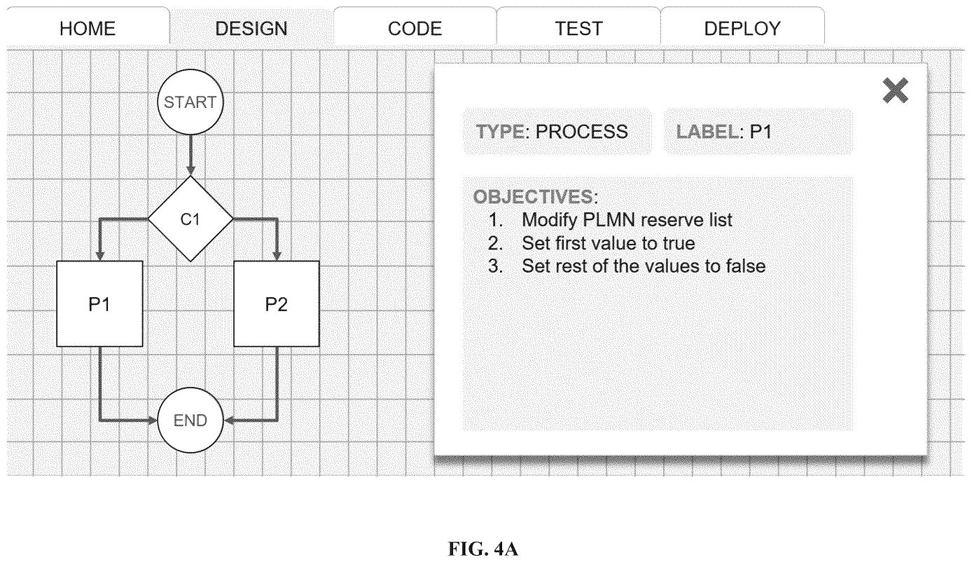

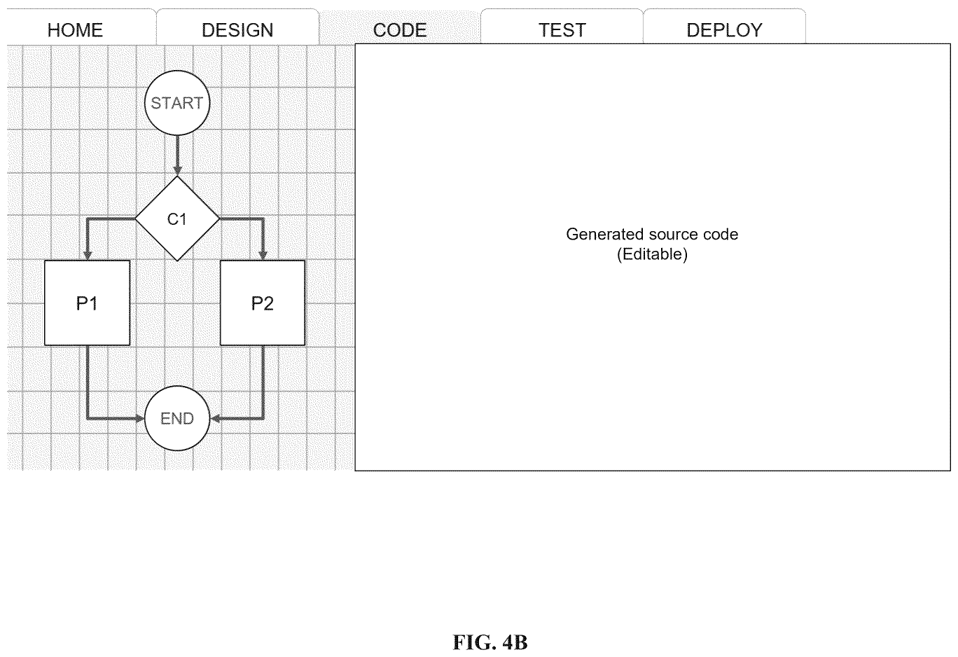

FIG. 4A illustrates an example graphical authoring interface that may allow a user to construct and define a flowchart, in accordance with some embodiments. A canvas on the left may present START/END, PROCESS, and DECISION nodes connected by directed edges. A properties panel on the right may open when the user selects a node or an edge and may permit the user to set a type (for example, PROCESS), a label (for example, “P1”), and one or more objectives expressed as natural-language statements or pseudocode. An edge selection may similarly expose a control predicate field that the system may treat as a boolean expression for a DECISION node's outgoing branches.

In some embodiments, when the user edits the properties shown in FIG. 4A, the system may persist the edits into the typed graph described above. The node record may store a stable identifier, the node kind (for example, PROCESS or DECISION), and port annotations; the objectives field may be attached as the node's “description.” The typed graph may enforce well-formedness rules, such as DECISION nodes producing true/false control edges, and may reject type-incompatible connections at edit time.

In this design, a user need not know domain-specific variable names to author objectives. In some embodiments, as the user types objectives (for example, “Modify PLMN (Public Land Mobile Network) reserve list; set first value to true; set rest to false”), a normalizer may standardize the text (lowercasing non-literals, expanding abbreviations, and producing a normalized string and an embedding) and associate those artifacts with the node. These normalized artifacts may be consumed by the retriever and schema-constrained mapper to identify canonical domain terms from the knowledge base without requiring the user to supply exact table, column, or API identifiers.

In some embodiments, the interface may optionally surface suggestions drawn from the knowledge base as the user types, such as candidate domain terms that match the objectives' semantics and satisfy typed-graph constraints (for example, Boolean array fields under a “reserve list” table). In some embodiments, when multiple candidates remain, the panel may present an adjudication control that lets the user choose among candidates, and the selection may be stored as supervised training data for subsequent fine-tuning of the domain-specific model.

In this example, objectives may be multi-line and ordered. In some embodiments, the system may parse enumerated objectives into sub-steps that the planner later lowers into assignments, conditionals, or loops in the intermediate representation. For the PLMN example above, the planner may infer an indexed assignment pattern (set index 0 to True, set indices 1 . . . n to False) and may emit parameterized statements or API calls that operate on the canonical domain term bound by the mapper.

FIG. 4B illustrates an example split-view interface in which the user-defined flowchart may remain visible on the left while a code view on the right may display target-specific code generated from the typed graph and the bound domain terms. In some embodiments, the code generator may emit parameterized data-access statements (for example, prepared SQL) and API client invocations resolved from interface specifications in the knowledge base, and may show the resulting source text with syntax highlighting.

The code view may be editable in certain modes. In some embodiments, edits made in the code view may be validated against the typed intermediate representation and the knowledge base before acceptance, and provenance links may allow the user to click a line of code to highlight the originating node (or vice versa). The system may record the flowchart revision and code-generation manifest so that subsequent regeneration remains reproducible.

In some embodiments, status indicators may be shown near the tabs (for example, CODE or TEST) to reflect pipeline progress. After generation, the user may trigger unit-test synthesis and sandbox execution; results may be summarized inline with links to failing paths that, when selected, may highlight the corresponding DECISION or PROCESS nodes on the canvas. This integrated feedback loop may enable the user to refine objectives in natural language and immediately observe their effect on emitted code and tests.

The user-interface layouts depicted in FIGS. 4A and 4B are illustrative. Other implementations may use different widget placements or interaction styles while providing the same underlying behaviors: authoring or importing a flowchart, attaching objectives as node descriptions in natural language or pseudocode, mapping those descriptions to canonical domain terms from a knowledge base under typed-graph constraints, and generating executable code that can be tested and deployed.

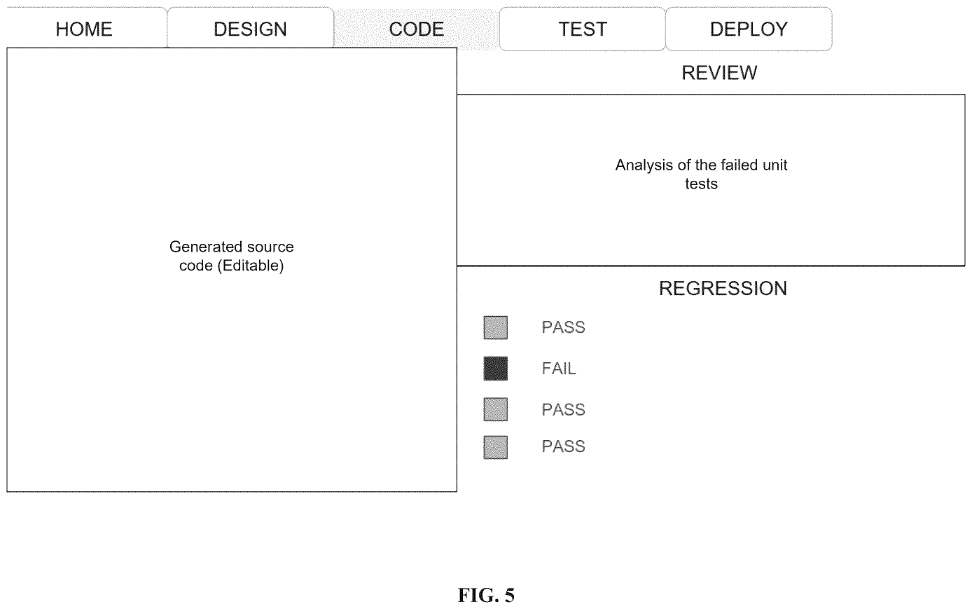

FIG. 5 illustrates an example test interface that may present results of automatically generated unit and path tests, in accordance with some embodiments. A code pane on the left may display the currently emitted source code (optionally editable), while a results pane on the right may include a “REVIEW” area that summarizes analysis of any failing tests and a “REGRESSION” area that lists individual test cases with status indicators (for example, green for PASS and red for FAIL).

In some embodiments, the tests shown in FIG. 5 may be synthesized from the typed intermediate representation and knowledge-base types, as described above. For each DECISION node in the flowchart, the system may generate at least two tests to exercise alternative outcomes; boundary-value tests may be derived from declared domains (e.g., percent fields ∈ [0,100], nullability, units). External data-access and API calls referenced by the emitted code may be isolated behind generated mocks or provisioned fixtures so that tests execute deterministically in a sandboxed runtime.

As shown, the REVIEW region may display machine-generated diagnostics for any failures, which may include assertion diffs, sanitized stack traces, and links to the originating node(s) in the flowchart. In some embodiments, the analysis may incorporate suggestions from a runtime error handler—such as inserting a type cast when a parameter type mismatches the schema or adding a null check—together with a “propose fix” control that, when accepted, may patch the intermediate representation and re-run the affected tests.

The REGRESSION list may show all tests relevant to the current flowchart revision and knowledge-base version. Selecting a row may highlight corresponding basic blocks in the typed intermediate representation and the associated lines in the code pane. In some embodiments, coverage metrics (for example, line and branch coverage) may be computed and displayed inline; advancement to packaging or deployment may be gated by thresholds specified in the configuration manifest.

Where the user edits code directly, the interface may validate edits against the typed intermediate representation and the knowledge base before accepting them, and may automatically schedule re-synthesis of affected tests. If the flowchart is modified, a regression run may be triggered; newly added or changed nodes may cause new tests to appear in the REGRESSION list, and prior passing tests may be re-executed to ensure non-regression.

Although FIG. 5 depicts one layout, other implementations may present equivalent information differently while providing the same underlying functionality: automatically synthesized tests derived from the flowchart's typed structure, sandboxed execution with mocks/fixtures, detailed failure analysis linked to flowchart nodes and emitted code, and policy-controlled gating of packaging and deployment based on recorded test results.

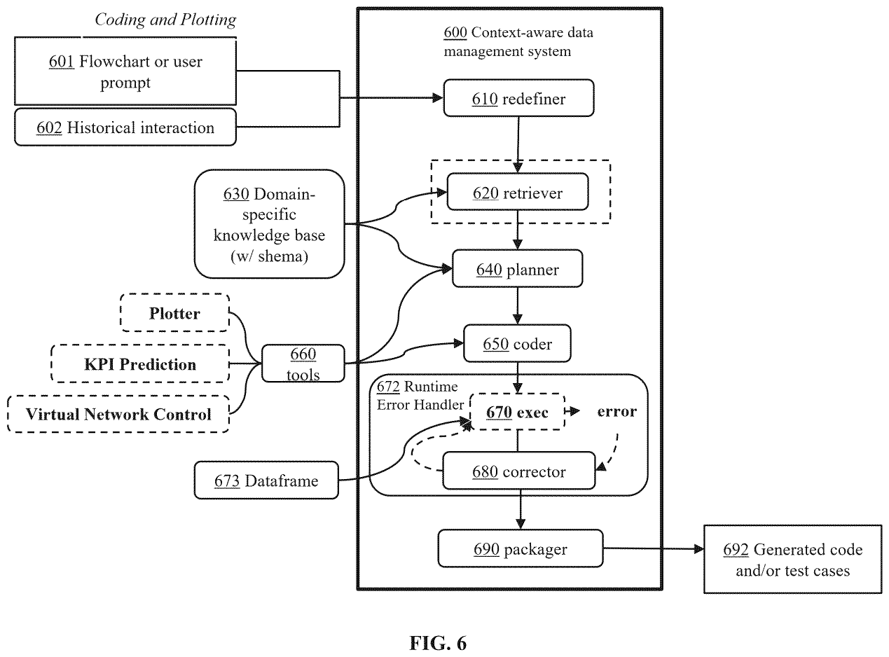

FIG. 6 illustrates a system diagram of a context-aware data management system supporting the system, in accordance with some embodiments.

As outlined in the background section, in today's data-driven organizations, the ability to access and analyze complex datasets is essential for informed decision-making. Databases store vast amounts of technical data, which can yield valuable insights when queried effectively. Similarly, code repositories house existing code containing specific elements, such as functions, classes, variables, and macros. For simplicity, the following description uses databases as an example to represent all types of data-intensive systems, including code repositories.

Interacting with these databases typically requires specialized knowledge of query languages, programming skills, and an understanding of complex database schemas. This creates a significant accessibility barrier for users who lack technical expertise but require data insights to perform their roles effectively.

Traditional data retrieval systems often rely on structured query languages like SQL or require users to write code in programming languages such as Python. These methods necessitate a steep learning curve and are impractical for users whose primary expertise lies outside of technical fields. Consequently, non-technical users are dependent on technical staff to extract and interpret data, often leading to delays and inefficiencies in the decision-making process.

Moreover, within large organizations, different departments and teams often develop their own specialized terminologies, acronyms, and jargon. This lack of standardized language presents additional challenges for data retrieval systems. Conventional systems struggle to interpret these unique terms, resulting in miscommunication, incorrect data retrieval, and reduced overall efficiency.

Existing solutions lack the adaptability to accommodate the dynamic and evolving language used by various user groups within an organization. They are typically static and cannot learn from user interactions or adapt to new terminology over time. This inflexibility hampers the system's ability to provide accurate and relevant responses to user queries, especially as organizational language evolves.

With the advancement of large language models (LLMs), some existing systems have attempted to enhance data retrieval by combining domain-specific retriever-augmented generation (RAG) systems with general-domain LLMs. In these configurations, the general-domain LLM serves as an interface, handling communication with the user in natural language, while the domain-specific RAG system stores vector embeddings of domain-specific documents and data entries. When a user submits a query, the domain-specific RAG identifies the most relevant documents or data entries, and then generates a response that incorporates the retrieved domain-specific information.

While this approach enables general-domain LLMs to ingest and integrate domain-specific information into their responses, it comes with significant limitations. First, this approach fails to provide customized or personalized interface for different users (e.g., departments or teams) using different terms or expressions to refer to the same technical term or data set. Second, another major drawback is that these systems are primarily designed for information retrieval rather than active data management, which includes taking actions on the retrieved data. The general-domain LLM and the RAG system work in tandem to retrieve relevant documents or data, but neither has the capability to generate executable code, manage database operations, or modify the underlying domain-specific datasets. For complex technical fields, where dynamic database management is required alongside information retrieval, these systems fall short of addressing more advanced user needs, such as generating or executing database queries.

Additionally, the reliance of traditional RAG systems on vector similarity for retrieving documents or parameters introduces challenges, especially when handling large datasets with closely related terms or concepts. Vector similarity methods, while effective at identifying general relationships, often struggle to capture subtle semantic differences between related terms. For instance, in a telecommunications network, terms like “network load,” “cell load,” and “user load” may share similar vector embeddings, but they refer to distinct technical concepts. Traditional RAG systems may not have the necessary depth of understanding to differentiate between such terms, leading to ambiguous or inaccurate results.

As the size of the dataset grows, this ambiguity compounds, making it increasingly difficult for RAG systems to maintain accuracy. The precision of retrieval becomes critical, as any errors or imprecise mappings at the retrieval stage directly affect the quality of the generated answers. Consequently, if a retrieval system incorrectly identifies or conflates related parameters, the final response provided by the LLM may fail to align with the user's original intent, reducing the system's overall utility and effectiveness.

To address the limitations of existing solutions, this application introduces the context-aware data management system 600. For illustration, FIG. 6 depicts an example of the context-aware data management system 600 and its interaction with domain-specific information. For instance, the system mentioned above must convert user-level natural language descriptions (e.g., in a flowchart component or a user prompt) into the technical terms used in backend databases or code repositories. This conversion process may utilize the context-aware data management system 600.

Initially, the domain-specific information may be retrieved from domain-specific databases (or code repositories). The domain-specific information may include structural details, such as column names, data formats, internal definitions, and acronyms specific to the database in question. To incorporate these databases into the system 600, users can upload database credentials, allowing the system 600 to securely log in and learn the structure of the database. This involves identifying each column and understanding its associated description and metadata. Additionally or alternatively, users may upload schemas in various formats, such as CSV, PDF, or XML files, each containing a comprehensive description of the database columns and their definitions. These uploaded schemas help the system 600 recognize the relationships between different data fields, enabling it to efficiently interpret user queries and map them to the correct parameters within the database. Through this process, the system 600 builds a domain-specific knowledge base and schema 630, storing the data schemes, column descriptions, acronyms used in the database, internal terms in the database, metadata associated with the database, data formats (e.g., percentage, number, fraction), and other domain-specific terms.

The knowledge base and schema 630 serves as a reference that the system 600 uses to understand the unique language of the domain, including the internal definitions and specific terminology employed within the user's organization. This enables the system to parse natural language queries accurately, interpreting terms and phrases that may otherwise be ambiguous without a proper understanding of the context. For instance, the system 600 can differentiate between terms like “load” or “capacity” by referencing the definitions learned from the uploaded databases.

Furthermore, the system 600 can leverage various tools 660 or APIs for managing and accessing the database (or functions or classes/objects provided by the code repositories), which can be incorporated into the system 600 during the setup phase. These tools 660 may include programs such as dashboards for visualizing data, KPI predictors for forecasting key performance indicators, and virtual network controller such as TeraVM controls for network testing and management. In some embodiments, the tools 660 may expose or register their respective APIs in the system 600. This registration process could involve securely exchanging API keys or tokens, ensuring the system has the appropriate permissions to access the tools. These domain-specific tools 660 may be used behind the scenes to carry out user requests, such as generating reports, predicting performance metrics, or controlling specific elements of the network. In some embodiments, the system 600 can also directly query databases using protocols like SQL or GraphQL to extract real-time data or execute commands on the tools 660. Additionally, Remote Procedure Calls (RPCs) may be used to remotely invoke specific functions in the tools 660, enabling the system 600 to control network elements or simulate conditions like network load, with results returned for further processing.

In some embodiments, the context-aware data management system 600 may include a redefiner 610, a retriever 620, a planner 640, a coder 650, a runtime error handler 672, and a packager 690. In some embodiments, the knowledge base and schema 630 and/or the tools 660 may be integrated into the system 600 as well.

To illustrate the workflow of system 600, an example user inquiry involving coding and plotting is shown in FIG. 6. In this scenario, the user prompt 601 includes a natural language query that triggers a search for specific data from the domain-specific database and executes the relevant tool(s) on the retrieved data.

In addition to the user prompt 601, the current user's chat history 602 or previous interactions with the system 600 may also be used as an input to the system 600. In some cases, this history data 602 is stored in a memory space associated with the query session and can be used to train the system 600 for subsequent queries. In other cases, the user may explicitly provide the history data 602 to offer the system 600 additional context. This historical data 602 provides valuable context to the system regarding how the particular user interacts, including their inquiry style, preferred terminology, system responses, and/or feedback.

In some embodiments, the redefiner 610 may be configured to reformat the user inquiry into a standardized format and perform vectorization and embedding on the standardized inquiry. For example, the user inquiry may be fed into a first LLM as a prompt, where the first LLM utilizes a transformer-based neural network architecture to process the prompt and generate a standardized representation of the natural language query. An embedding engine may then create query-specific vector embeddings based on this standardized representation of the natural language query.

Standardizing the user inquiry before vectorization is designed to improve the accuracy of the vectorization step. Natural language queries often contain variations in phrasing, terminology, or syntax, which can introduce ambiguity during the embedding process. By reformatting the inquiry into a consistent, standardized structure, the system reduces variability and ensures that semantically similar queries are treated consistently during vectorization. This step enhances the precision of the embedding engine, as the model can more accurately capture the underlying intent and meaning of the query, leading to improved retrieval and processing of relevant domain-specific information.

For example, consider two user inquiries: “How many users are connected to the 5G network?” and “What is the number of users currently on the 5G network?” Although these inquiries are phrased differently, they essentially ask for the same information. The standardization process would reformat both inquiries into a uniform representation, such as “Retrieve current number of users connected to the 5G network.” This standardized version removes variations in phrasing and allows the embedding engine to generate more accurate vector embeddings that focus on the core meaning of the query, improving the system's ability to retrieve the correct data.

After obtaining the vector embeddings of the natural language terms in the user inquiry, the retriever 620 is configured to perform a hybrid retrieval to identify the domain-specific terms from the knowledge base and schema 630 that correspond to the natural language terms. The hybrid retrieval process involves an initial vector-based search of the knowledge base embeddings (also called a domain-specific vector base) to identify a plurality of candidate domain-specific terms, such as a database table name, a column name, a variable, or a data type of the database that correspond to the vector embeddings of the natural language term. This vector-based search is followed by a fine-tuned, domain-specific LLM performing a secondary filtering of the candidate terms to accurately identify the domain-specific terms that match the natural language terms in the user inquiry. The fine-tuned LLM may take the identified domain-specific terms as input to generate a domain-specific query.

In some embodiments, the system is applied to Radio Access Network (RAN) operations where the generated artifacts are packaged as rApp bundles for execution within an SMO-managed environment that hosts the non-RT RIC. The rApp code produced by the system runs as one or more Kubernetes workloads with pinned dependencies and exposes health, metrics, and control endpoints compatible with operator tooling (for example, HTTP health checks and OpenMetrics/OTel telemetry). At runtime, the rApp ingests performance-management data obtained by the SMO over O1 (the O-RAN management interface between the SMO and O-RAN managed elements used for FCAPS functions such as performance and configuration management) and correlates those KPIs (e.g., per-cell PRB utilization, handover failure ratios, RRC setup success rates, QoS/throughput distributions) with topology and inventory data. Using the schema-grounded mappings compiled from the flowchart, the rApp executes analytics (such as congestion detection, coverage/capacity imbalance identification, or energy-savings opportunity discovery) and then enacts closed-loop control by emitting standards-conformant actions: for example, posting A1 Policy updates (A1 being the O-RAN interface from the SMO/non-RT RIC to the near-RT RIC for policy guidance, enrichment information, and ML model management) toward the near-RT RIC to steer traffic or adjust handover offsets, or issuing configuration changes via SMO workflows that target managed elements over O1 when policy is not sufficient. The same bundle can stage changes via canary rollout, verify effect by watching specific KPIs, and automatically roll back on probe failures. In practical deployments, this enables operator tasks such as hotspot mitigation (detecting cells whose PRB utilization and handover failure trends exceed thresholds and pushing A1 policies to shift load to neighbors), neighbor-relation optimization (recomputing and applying NRT updates when mobility KPIs degrade), and energy savings (curating off-peak sleep schedules for carriers or sectors and restoring capacity based on forecast demand), all without manual scripting and with full auditability inside the SMO.

For example, in the context of a RAN, a user may query about the status of “network handovers” in a 5G network. Suppose the user submits a query: “What is the current status of handovers in the network?” Initially, the redefiner 610 transforms the query into a standard format, e.g., “status of handovers,” and the retriever 620 may convert the natural language terms, such as “status” and “handovers,” into vector embeddings and perform a search within the domain-specific knowledge base. This vector-based search might identify several candidate terms related to handovers, such as “successful handovers,” “failed handovers,” “handover latency,” and “handover attempts.” At this stage, the redefiner 610 only gathers and displays candidate terms.

Next, the fine-tuned LLM in the retriever 620 further refines these candidate terms by considering the context information, such as user's previous interactions with the system or their specific role within the organization. If the user's previous queries have shown a consistent focus on troubleshooting network performance issues—particularly on monitoring failure rates or error processes-the LLM would prioritize terms such as “failed handovers” and “handover latency.” Additionally, if the user is part of a team responsible for network stability and troubleshooting, the system would align the response to focus on identifying network inefficiencies, rather than routine operations like “successful handovers.” In some embodiments, the user-selected terms are stored along with the natural language terms as the training data to further fine-tune the domain-specific LLM.

As a result, the system generates a more precise query tailored to the user's historical preferences and role, such as “retrieve the current failure rate and latency for handovers in the 5G network.” By leveraging the user's previous queries and profile, the system ensures that the most relevant and actionable data is retrieved, focusing on the aspects of the network handovers that align with the user's interests in troubleshooting and network stability. This approach provides the user with more meaningful results that are closely aligned with their professional needs and operational focus.

The hybrid solution offers a significant technical advantage over traditional RAG systems by leveraging a two-step process for identifying domain-specific terms. In the hybrid approach, the vector-embedding search serves as an initial, less stringent mechanism for identifying a broad set of candidate terms, without needing to pinpoint the optimal term or terms immediately. This relaxed requirement allows the system to quickly narrow down potential matches. The fine-tuned LLM then refines this list by considering additional context, such as the user's historical interactions and profile, to filter out the most relevant domain-specific term or terms. In contrast, traditional RAG systems must rely solely on vector similarity to identify the optimal term based only on the current user query, with no awareness of prior interactions or user preferences. This often leads to less accurate results, as traditional RAGs do not incorporate valuable context to distinguish between closely related terms.

After the domain-specific terms are identified by the retriever 620, the planner 640 may generate a sequence of coding instructions based on the identified domain-specific terms, the corresponding information in the knowledge base and schema 630, and/or the natural language query. For instance, the domain-specific terms may include specific table names and/or column names in the database. The information in the knowledge base and schema 630 corresponding to the tables or columns may include data types, formats, or other relevant details required to accurately construct a database probe. This information, when combined with the domain-specific terms, allows the planner 640 to generate the appropriate query for retrieving the necessary data. Additionally, the natural language query may provide further instructions regarding the desired action to be performed on the query result, such as plotting a visualization, generating a file in a specific format (e.g., CSV, JSON), setting up alerts based on specific thresholds, or performing statistical analysis. By considering these inputs, the planner 640 can efficiently generate coding instructions to fulfill the user's request and interact with the database in a context-aware and action-oriented manner. In some embodiments, the planner 640 may be implemented using tools like OpenAI GPT, Codex, or Google PaLM, which can be used to translate natural language queries into step-by-step coding instructions.

The coder 650 may receive the sequence of coding instructions generated by the planner 640 and, based on these instructions, generate executable code in an interpreted programming language compatible with the database's APIs. The code is designed to interact with the domain-specific database or perform other actions as specified in the user's natural language query. The coder 650 translates the high-level coding instructions into low-level programming constructs, using appropriate languages such as Python, SQL, or other appropriate programming languages, depending on the nature of the task. For instance, if the instruction involves querying a database, the coder 650 may generate a python code or an SQL query with the necessary SELECT, WHERE, and JOIN clauses based on the table names, column names, and data formats provided by the planner 640. If the query result is intended to be visualized, the coder 650 can incorporate libraries such as Matplotlib or Plotly to generate plots. Similarly, if the result needs to be exported, the coder 650 can write scripts that output the data in formats like CSV or JSON. Additionally, the coder 650 can embed logic for setting up alerts or thresholds, which may involve creating triggers within the database or scheduling tasks for continuous monitoring. In some embodiments, the coder 650 may be implemented using tools like Codex, DeepMind AlphaCode, or GitHub Copilot, which can generate executable scripts in languages like Python or SQL from these high-level instructions.

The runtime error handler 672 includes a runtime environment (denoted as exec 670 in FIG. 6) in which the executable scripts generated by the coder 650 are executed. In some embodiments, the scripts may interact with Python data structures, such as DataFrames (commonly used in data manipulation libraries like Pandas), to organize, filter, and process the data.

The runtime error handler 672 further includes a corrector 680 for catching runtime errors, such as unhandled exceptions, execution failures, resource leaks, or other anomalies occurring during runtime. Depending on the nature of the runtime errors, the corrector 680 may automatically invoke predefined exception handling routines corresponding to the runtime error to update the code and resolve the issues.

For example, if code encounters an issue such as trying to access a non-existent column in a DataFrame 673, the corrector 680 can modify the code to either rename the column based on the correct schema or omit it from the query. Similarly, if code attempts to perform an unsupported operation on a DataFrame, such as dividing a string-based column by a numeric column, the corrector 680 can identify the error and adjust the operation by converting the data type. In cases where a resource leak occurs, such as an unclosed file handle or database connection, the corrector 680 can automatically insert code to properly release these resources after the DataFrame processing is complete. As another example, if code generates a syntax error (such as a missing semicolon or an incorrect function name), the corrector 680 can identify and modify the faulty line of code to fix the syntax, ensuring the code runs successfully. Similarly, in the event of a type mismatch error (e.g., the code attempts to use a string where an integer is required), the corrector 680 can adjust the variable type or add type casting to ensure compatibility. In cases of resource leaks (such as open database connections that are not properly closed), the corrector 680 may insert commands to release resources after their use, preventing memory issues or performance degradation. For more complex execution failures, like failed database queries due to missing fields, the corrector 680 can attempt to adjust the query by removing or replacing invalid field references.

In some embodiments, the execution of code may involve triggering one or more APIs (e.g., the tools 660) of the database for data retrieval or management, such as generating visualizations, making predictions, or executing network control commands.

For example, if the user inquiry requests plotting a performance summary, the code could query real-time data from the network database, aggregate it into a DataFrame, and use visualization tools (such as Matplotlib or Plotly) to generate visual outputs like line charts or heatmaps. These charts could be displayed on a dashboard, providing users with an intuitive way to interpret the data. Alternatively, the script may trigger a KPI predictor tool to analyze trends in the queried data and make predictions, such as forecasting potential network congestion points.

In more advanced use cases, the code may also interact with network control tools like TeraVM, triggering network configuration commands based on the obtained data. For instance, if the data reveals high traffic in a specific cell, the script may instruct the TeraVM tool to adjust radio resources dynamically, mitigating congestion. The ability to combine data retrieval with real-time actions ensures that the system not only answers the user inquiry but also provides actionable outcomes, such as optimizations or network adjustments based on the analyzed data.

In some embodiments, the optional packager 690 receives the output from the execution of the script and prepare it for final delivery. Once the script processes the user inquiry—whether by querying data, generating visualizations, or triggering network control actions—the packager 690 aggregates and formats this output into a cohesive response. The output may include raw data, visual representations (such as graphs or charts), predictions, or network commands. The packager 690 ensures that these various elements are properly organized, converted into the appropriate formats, and optimized for the type of response required by the user.

Once the output is packaged, it is passed on to generate the response 692. This response 692 could take different forms depending on the user's original request, such as displaying the generated code, code review, test results, a visual chart on a dashboard, a downloadable file in formats like CSV or JSON, or presenting insights directly within the system's user interface. Additionally, the response 692 may include action-based outputs, such as confirmation of a network control command execution.

FIG. 7 illustrates the fine-tuning process and deployment of the domain-specific LLM in the context-aware data management system, as part of the supporting the system, in accordance with some embodiments.

The fine-tuning process of the domain-specific LLM in the context-aware data management system involves several stages designed to refine the model's ability to map natural language terms to domain-specific technical parameters. This process begins with gathering relevant data sources, followed by generating fine-tuning data through a two-step process involving both a generic LLM and human feedback, and finally fine-tuning the domain-specific LLM based on these mappings.

As shown in FIG. 7, the fine-tuning process starts with two data sources: domain-specific data 710 and user interactions 720. The domain-specific data 710 may encompass technical information such as Service Management and Orchestration (SMO) data, database schemas, parameters, formula knowledge, and other system-related data. This data serves as the technical foundation for fine-tuning, detailing how the system's data is structured and how various parameters interact. User interactions 720 track all the natural language queries and inputs provided by users, along with their objectives and other interaction patterns. These interactions help the system identify how users phrase their queries and what technical results they seek. By recording this data, the system can incorporate personalized usage into the fine-tuning process, enhancing the LLM's ability to understand and respond to user-specific language.

The fine-tuning data generation process is performed in two steps using a generic LLM and human feedback 730. In the first step, the generic LLM absorbs both domain-specific data 710 and historical user interactions 720, generating mapping pairs between technical terms and the natural language terms commonly used by the user. For example, a user query like “How can I adjust the signal strength of the 5G cell tower?” might be mapped to technical parameters such as adjust_signal_strength, cell_tower_id, and network_type=‘5G’.

The second step involves human validation—the system presents these generated pairs to human users, who can then review, edit, and purge the generated mappings as needed. This human feedback ensures that only accurate and context-appropriate mappings are stored. The validated mappings are saved as fine-tuning data 740 in the form of key-value pairs, where the key represents the natural language term, and the value represents the corresponding technical term or database parameter.

Once the fine-tuning data 740 is generated, the fine-tuning step 750 uses these key-value pairs to train the domain-specific LLM. This training allows the model to learn the mapping relationship between natural language queries and domain-specific technical parameters. The process utilizes existing LLM tools, which support user-provided training data, making it possible to refine the model based on the specific needs of the domain.

In some embodiments, in addition to the key-value pairs, the natural language terms from historical user queries are also considered during the fine-tuning process. The domain-specific data 710 and user interactions 720 provide essential context for this step, ensuring that the LLM is not only capable of understanding the technical language of the system but also how users naturally interact with it.

For example, if a user frequently asks how to adjust network parameters, the LLM will be fine-tuned to recognize similar future queries and map them to the appropriate technical actions, such as adjust_signal_strength. This enables the domain-specific LLM to respond accurately and efficiently, continuously improving based on real-world user interactions and domain-specific knowledge.

The fine-tuning process may be performed periodically (e.g., after collecting a certain number of user interactions) or triggered upon the creation of new domain-specific data. Once a round of fine-tuning is complete, the deployment of the fine-tuned LLM involves receiving a natural language query 760 and executing a two-step retrieval process, which includes a vector search followed by refinement using the fine-tuned LLM 770. The output of this process is a set of technical parameters 780 that are domain-specific and correspond to the natural language terms in the user query 760.

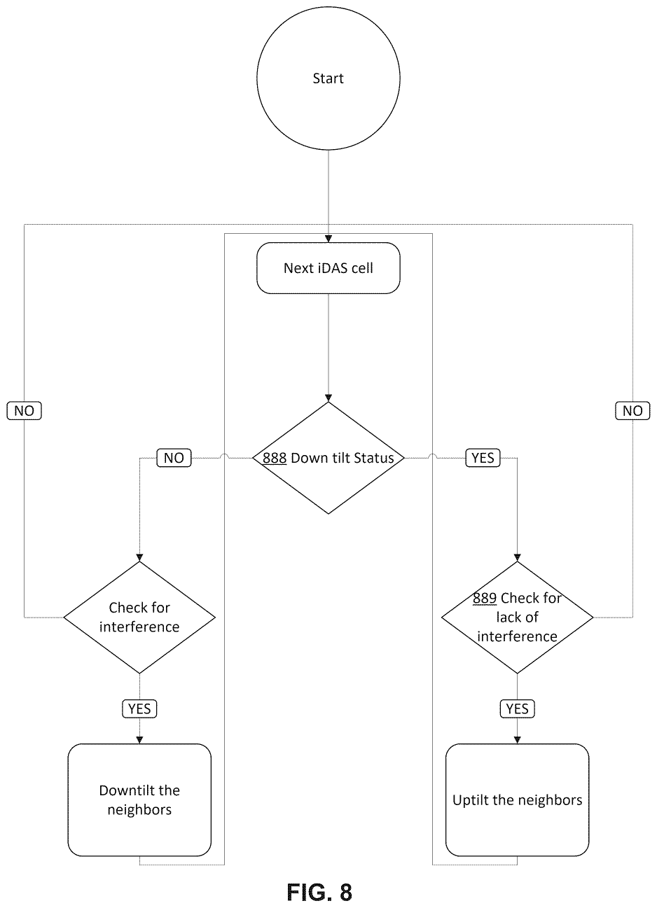

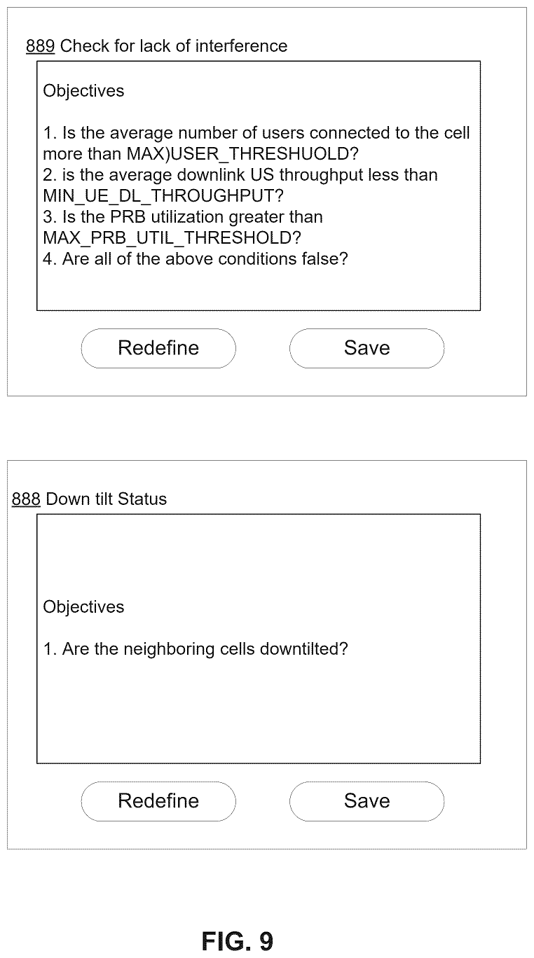

FIGS. 8 and 9 together illustrate an end-to-end example in which a stadium optimization policy is authored as a flowchart and realized as deployable code, in accordance with some embodiments. In particular, FIG. 8 illustrates an example flowchart describing a dynamic network management process in telecommunications for optimizing wireless connectivity in high-density environments such as stadiums, and FIG. 9 illustrates example node objectives in the flowchart of FIG. 8.

The engineering goal of the flowchart in FIG. 8 is to iterate over indoor-DAS (iDAS) cells, assess interference conditions created by surrounding macro neighbors, and adjust those neighbors'antenna tilts to balance coverage and capacity across pre-event, in-event, and post-event phases. A process block labeled “Next iDAS cell” represents an iteration that enumerates iDAS cells from topology or inventory. A decision node 888 (“Down tilt Status”) branches on whether the relevant macro neighbors for the current iDAS cell have already been down-tilted. If not, a left branch evaluates interference by consulting performance indicators; when interference is confirmed, an action block applies a down-tilt to the neighbors to suppress overspill into the venue. If the neighbors are already down-tilted, a right branch evaluates whether interference is now absent at the iDAS cell; when the absence of interference is confirmed, an action block applies up-tilt to the neighbors to restore broader macro coverage as the event winds down. Loop back edges return control to the “Next iDAS cell” block until all targets are processed.

FIG. 9 shows how a user may define the execution logic of decision nodes 888 and 889 using natural-language objectives rather than domain-specific identifiers. For node 889 (“Check for lack of interference”), the user may state objectives such as whether average users exceed a maximum threshold, whether average downlink throughput falls below a minimum threshold, whether PRB utilization exceeds a maximum threshold, and whether all of the above conditions are false. For node 888 (“Down tilt Status”), the user may state an objective such as whether neighboring cells are currently down-tilted. These statements are captured as the node descriptions of the typed graph and need not name any particular KPI column, API, or configuration knob; the system later maps the phrases to canonical domain terms in the knowledge base.

In some embodiments, when the objectives in FIG. 9 are entered, the editor (e.g., the editing module of the Flow2Code system) may normalize each objective into a standardized phrase and an embedding and attach both artifacts to the corresponding node in the typed graph. The visual structure of FIG. 8 may be encoded as graph features (node kinds, true/false edge polarity, loop depth, and adjacent port types). The normalizer and visual encoder provide inputs to a retriever that queries lexical and vector indices over the knowledge base. For the phrase “average number of users connected to the cell,” the retriever may return candidate domain terms such as a counters table field representing UE count, an analytics view providing a moving average of connected users, and a similarly named KPI used in a different layer; type descriptors, units, and governance tags accompany each candidate.

A schema-constrained mapper may select from the candidate set by executing a domain-specific model conditioned on the normalized phrase, the FIG. 8 node kind (e.g., DECISION), and typed-graph constraints that expect boolean outcomes. Candidate domain-specific terms whose declared types are incompatible with a DECISION predicate or whose units do not match an inequality test against the declared threshold may be down-weighted. Where ambiguity remains, the UI may surface a top-K list; the user's choice may be recorded and applied to other nodes that reuse the same phrase. The mapper may also bind the threshold symbols in FIG. 9 (for example, MAX_USER_THRESHOLD, MIN_UE_DL_THROUGHPUT, and MAX_PRB_UTIL_THRESHOLD) to configuration entries that the knowledge base marks as numeric with appropriate units and default ranges.

After bindings are established for nodes 888 and 889 and any other nodes in FIG. 8, a planner may lower the typed graph to a typed intermediate program representation (IR) that encodes the loop over iDAS cells, the decision predicates, and the two action blocks. In some embodiments, the planner may compute dominance and insert φ-functions at merge points so that variables such as “neighbor_tilt_state” and “interference_ok” remain well-typed along all paths. The action blocks may resolve to parameterized API invocations that either post policy to a runtime controller or stage a configuration workflow against the managed elements that implement antenna tilt; the specific interface may be chosen from the knowledge base's interface specifications for the operator's environment.

As used herein, to “lower” a flowchart means to transform the high-level typed graph into a machine-executable intermediate program representation (IR) with explicit control flow and data dependencies. In some embodiments, lowering may construct a control-flow graph of basic blocks, compute dominator and post-dominator relations, and translate each node into typed IR operations. A DECISION node may be lowered into a predicate-construction subgraph followed by a branch_if to “true” and “false” successors; a PROCESS/EXECUTION node may be lowered into one or more effectful calls whose parameter shapes and types are taken from the knowledge base; and a LOOP scope may be lowered into a header block, a back-edge, and an exit block with-functions at merge points to produce static single-assignment form. Data-flow edges become SSA values carried between producer and consumer blocks, and port annotations (types, units, nullability) are preserved as IR type descriptors. During lowering, normalization passes may insert implicit casts required by unit or nullability rules, fold constants, eliminate dead code, and attach provenance to each operation (node ID, schema version, and selected domain term) so that the same graph deterministically re-lowers to the same IR. External resources are modeled with an effect system that distinguishes pure computations from data-access and control actions, allowing the scheduler to introduce retry, timeout, and transaction scopes in later code-generation passes. or example, node 889 (“Check for lack of interference”) may be lowered into IR that loads recent KPI windows via load_kpi (cell_id, metric_id, window), computes aggregates such as avg_users, avg_d1_tp, and prb_util, compares them to bound thresholds, combines results with logical operators to form predicate no_interference, and emits branch_if no_interference->up_tilt_block else->next_check. Node 888 (“Down tilt Status”) may be lowered into a predicate that reads neighbor state and branches to either an interference-check block or an up-tilt block. The subsequent code-generation stage then emits target-specific statements and API calls from this IR; “lowering”is distinct from final code emission.

Subsequently, a code generator may emit target-specific code from the intermediate representation (IR). In some embodiments, the code generator may produce data-access statements that query the performance-management store for the current iDAS cell's KPIs over a time window, compute aggregations needed by the objectives in FIG. 9, and evaluate the node predicates. The code generator may also produce client calls to a controller or orchestration component to down-tilt or up-tilt the identified neighbors when a predicate evaluates to true. Retry policy, idempotency keys, and transaction scopes may be inserted according to the interface specifications associated with each call. The same pass may emit a configuration manifest declaring dependency versions, environment variables, logical secret references for API credentials, network endpoints for metrics and health probes, and rollout policy.

In some embodiments, unit and path tests may be synthesized automatically from the intermediate representation and the types resolved by the knowledge base. For node 888, tests may cover both outcomes when neighbors are reported down-tilted and not down-tilted. For node 889, tests may include boundary cases—user count exactly at MAX_USER_THRESHOLD, throughput at MIN_UE_DL_THROUGHPUT, and PRB utilization at MAX_PRB_UTIL_THRESHOLD—and a case where all conditions are false to confirm the “lack of interference” branch. External calls that read KPIs or effect tilts may be isolated behind generated mocks so tests run deterministically. Coverage gates may be enforced before packaging proceeds.

When tests pass, a packager may assemble a deployable runtime that includes the emitted code and the configuration manifest. In some embodiments, the packager may build a container image and, where the target is a RAN management environment, also construct a bundle suitable for installation on a service-management platform. Health and metrics endpoints declared in the manifest may be exposed so that the deployment system can probe liveness, readiness, and key indicators such as the count of cells processed per minute and the distribution of policy actions taken.

At runtime, the deployed application may enumerate iDAS cells from topology, query recent KPIs, and evaluate node 888 and node 889 predicates for each cell. When interference is detected and neighbors have not yet been down-tilted, the application may issue a down-tilt action against those neighbors and record the action with the associated KPI snapshot and schema-version identifier for audit. When the absence of interference is confirmed and neighbors remain down-tilted, the application may issue an up-tilt action to restore coverage. The loop may continue until all iDAS cells are evaluated; on subsequent runs, the application may pick up where it left off using persisted state to avoid duplicated actions.

The coupling of FIG. 8's visual logic with FIG. 9's natural-language objectives may allow a domain operator to express intent without supplying database column names or controller endpoints. The mapping to canonical terms, the typed lowering and stitching, the synthesis of tests, and the packaging into a monitored deployment may together realize the flowchart as a safe, auditable closed-loop program that adjusts tilt decisions across the event lifecycle in a reproducible and policy-controlled manner.

### An Example Embodiment of the Flow2Code System

### UI and Ambiguity Detection

The flowchart editing interface provides an intuitive and interactive canvas on which users can visually construct their desired logic. Each shape on this canvas represents a specific code logic construct, such as conditions, loops, or execution steps.

In some embodiments, as the user hovers their cursor over a particular flowchart block, a contextual icon dynamically appears on or beside that block, acting as a visual cue for further interaction. When the user clicks on this icon, a pop-up panel or overlay is displayed, containing the natural language-based objectives associated with that block. Within this panel, the user can view, edit, add, or delete objectives, enabling iterative refinement of the logic's intent. Changes made in this panel are immediately reflected in the underlying code representation, ensuring that the flowchart and the generated code remain tightly synchronized.

Certain blocks, such as condition blocks, have predefined numbers of inlets and outlets, each corresponding to logically necessary connections. For instance, a condition block may have a single inlet and two outlets: one for the “true” branch and one for the “false” branch. The user interface assists in maintaining logical correctness by guiding users through these connections. If a user completes the flowchart but forgets to connect one of the required outlets, the interface provides immediate visual feedback. This may include a subtle warning icon on the block, a highlighted outline around the unconnected outlet, or a small tooltip describing the missing connection. This is to make errors easily discoverable and correctable without disrupting the user's flow.

In this system, each natural language objective defined within a flowchart block is transformed into a prompt for the fine-tuned LLM. The LLM interprets the objective and converts it into a query for the domain-specific knowledge base, which may be implemented using a retrieval-augmented generation (RAG) architecture. To achieve this, the system converts user-defined terms into vector embeddings that capture their semantic meaning. These embeddings are then used to search the knowledge base for domain-specific terms with similar embeddings. Such domain-specific terms might include variable names representing real-time metrics (e.g., “the number of active users on 5G band”) or code routines that implement similar functionality for obtaining the real-time metrics. The knowledge base is prepared in advance, with domain-specific terms pre-vectorized and indexed for rapid similarity queries.

Once the knowledge base returns a matching domain-specific term, the system merges it with the original objective. For example, a user-provided term “the number of active users using cell X” may be replaced with “ActiveUsersCellX_5G” if it is the closest domain-specific variable. This updated objective is then passed to the LLM again, prompting it to generate the code snippet implementing that objective in the chosen programming language. This approach allows the LLM to ground its output in domain-specific resources, ensuring that generated code references actual variables, tables, or functions available in the target environment.

In cases where the knowledge base returns multiple plausible matches, objective disambiguation is a useful advantage. If the user's original objective did not specify which band of the cell is in focus, and the knowledge base found multiple variables (e.g., one corresponding to 4G users and another for 5G users), the system may prompt the user for clarification. A pop-up window could list the top K matches in a drop-down menu, allowing the user to select the correct domain-specific term. In some embodiments, the system tries to infer intent from the broader flowchart context. If a prior block's objective already specified the 5G band, the LLM may assume consistency across blocks and automatically select the 5G-related term. Moreover, once clarified, this information can be broadcast to all other blocks using the same term, ensuring consistency and reducing the need for repeated user intervention.

While each block may execute its code-generation process independently in parallel LLM sessions (accelerating the code-generating process), the system maintains communication channels among these sessions to propagate user-defined clarifications and resolve interdependencies effectively.

### Code Generation and Stitching

The code-generation and stitching process begins with the platform translating each flowchart block into a discrete code snippet, also referred to as a function in the context of software development. Each flowchart block is defined by its natural language (NL) objectives, which are enriched through domain-specific term mapping. These terms are retrieved from a knowledge base using a combination of vector embeddings and context-aware querying. The enriched objective is then used as a prompt for the fine-tuned large language model (LLM), which generates a code snippet tailored to the logical construct of the block. For example, a condition block is rendered as an if-else statement, while a looping block is translated into a for or while loop. Execution blocks may generate function or method calls or procedural logic.

Once code snippets for individual blocks are generated, the platform proceeds to stitch these snippets into a cohesive program by analyzing the connections in the flowchart. Each connection in the flowchart represents a logical or data flow dependency between blocks. For instance, the outlet of a condition block (e.g., “true” or “false”) may connect to the inlet of an execution block or another condition block. These connections are translated into programmatic control structures, such as function calls, conditional branching, or iterative loops.

The system interconnects flowchart blocks by maintaining a structured mechanism for managing dependencies, variable states, and data flow, ensuring that outputs from one block can be seamlessly consumed by subsequent blocks in the generated code. When a user connects two blocks in the flowchart, the system identifies this connection as a logical dependency. During processing, it determines the source block (producer) responsible for generating the output and the target block (consumer) that requires this output as input. This dependency is mapped into a structured representation, forming the basis for how code snippets interact.

Each block's generated code snippet is treated as a standalone function, and the variables defined or modified within the block are tracked in a global state or symbol table. For instance, if the first block computes a variable x as its output, the system records x along with its type, scope, and context. When the subsequent block requires x for its logic, the system ensures that this variable is passed appropriately, either as a function parameter or through a shared context.

In some embodiments, the interconnection may be implemented through the use of function parameters and return values. The function representing the producer block returns the relevant output variables, while the consumer block's function accepts these variables as input. For example, a condition block that evaluates the value of x produced by an execution block is coded such that the value of x flows from the producer to the consumer function. The main program orchestrates these calls, ensuring that the execution sequence defined in the flowchart is preserved.

In cases where variables need to persist across multiple blocks or iterations, the system may use a shared context object or global store. This shared context acts as a repository for variables that are modified and accessed by multiple blocks, ensuring that the state remains consistent throughout the program. For tightly coupled blocks, the system may also choose to inline the output of one block directly into the input of another, reducing overhead and simplifying the code.

For more complex scenarios involving loops or nested conditions, the system ensures that variable scoping and data flow are properly managed. Loop variables are passed between iterations, and nested conditions are handled such that variables defined in specific branches are appropriately scoped and accessible when needed. Error handling mechanisms verify that variables being passed between blocks match the expected types and are in scope at the time of use. If a producer block fails to execute or does not return an expected value, fallback logic ensures that the program can proceed gracefully.

Errors may arise if the connections between blocks introduce circular dependencies, missing variables, or mismatched data types. The system detects such inconsistencies and either prompts the user for clarification or resolves them automatically using predefined error-correction patterns. Optimization is applied to eliminate redundant logic or streamline transitions between blocks, such as merging sequential execution blocks into a single function when feasible. These optimizations ensure that the final program is both efficient and readable.

The final output is a fully stitched program composed of interconnected functions, each corresponding to a flowchart block. The program maintains the modularity of its components, allowing users to isolate and modify specific blocks without disrupting the entire workflow. By adhering to the structure and logic defined in the flowchart, the platform bridges the gap between visual programming and executable code, enabling seamless translation of user intent into deployable software. This modular, connection-driven approach not only simplifies the development process but also ensures scalability and maintainability of the generated programs.

### Code Testing and Packaging for Deployment

The system incorporates a modularized approach to code testing by generating unit tests for each flowchart block independently. This testing strategy aligns naturally with the modularized code-generation process, where each flowchart block corresponds to a standalone function. The modularity ensures that each block's logic can be validated in isolation, free from the potential complexities and interdependencies of the overall flowchart. This approach leverages the strength of today's LLM-based code generation, which excels at handling discrete objectives for individual blocks. Attempting to test or generate code for the entire flowchart at once would introduce a higher risk of hallucination, where the LLM might misinterpret logic or generate erroneous outputs for interconnected components. By focusing on one block at a time, the system minimizes these risks and ensures a more robust testing framework.

To facilitate this modularized testing, the system generates unit tests specific to the logic of each block. These tests are designed to exercise all possible paths within the block's function, including edge cases and exceptional scenarios. For instance, a condition block that evaluates a variable and branches into “true” and “false” paths will have unit tests ensuring that both branches are executed and behave as expected. Similarly, looping blocks are tested across a range of iterations, including boundary cases like zero iterations and maximum thresholds. This exhaustive testing ensures that the logic within each block is accurate and reliable.

In cases where a block's logic relies on the output of another block, dummy functions are generated to simulate the cross-block interactions. These dummy functions are designed to produce all possible outputs that the dependent block might encounter during actual execution. For example, if a condition block depends on the output of a preceding execution block, a dummy function replaces the execution block during testing, generating a predefined range of possible outputs for the condition block to evaluate. This allows the unit test to validate the block's logic comprehensively, without requiring the actual code execution of the dependent block.

By modularizing both the code-generation and testing processes, the system ensures that the logic of each block is thoroughly validated before stitching the blocks together into a cohesive program. This approach isolates and resolves issues at the block level, preventing them from propagating into the final program. Furthermore, the use of dummy functions enables flexible testing of cross-block dependencies, ensuring that even blocks with external inputs are rigorously tested in isolation.

The packaging process for deploying the generated code involves converting the stitched flowchart-based logic into a complete, deployable application that is compatible with the intended runtime environment. This process is designed to ensure that the final output integrates seamlessly with the operational infrastructure, whether it is a standalone executable, a web application, or a containerized service for cloud deployment.

The first step in the packaging process is code integration, where the stitched program is combined with necessary runtime dependencies, libraries, and configuration files. For instance, if the generated code includes database queries or API calls, the required client libraries (e.g., SQL drivers or HTTP request libraries) are automatically added to the project. Additionally, the system scans the stitched code for any external library references, ensuring that all dependencies are resolved and included in the deployment package. This integration step also involves adding boilerplate code, such as main entry points and initialization scripts, to structure the application for deployment.

Once the code is integrated, the system generates configuration files tailored to the target deployment environment. These files may include environment-specific parameters such as database connection strings, API keys, or resource limits. For example, in a telecommunications use case, the configuration might specify network parameters like cell IDs or frequency bands. The system automates this process by extracting relevant information from the flowchart objectives or user inputs during design. It organizes these parameters into standardized formats such as .env files, JSON configuration files, or YAML manifests, depending on the deployment context.

The next step involves packaging the application into a deployable unit. This step depends on the deployment target.

For standalone deployments, the system compiles the application into an executable binary or a directory structure with all necessary files, ensuring that it runs independently on the target platform.

For web-based applications, the system bundles the code with a lightweight web server (e.g., Flask for Python or Express for Node.js) and prepares it for hosting on a cloud platform or server.

For containerized deployments, the system may build a container image. In some embodiments, the container image includes the emitted program and a base configuration manifest (e.g., configuration files) that declares the schema version, dependency pins, health/readiness probes, and logical secret references. Environment-specific configuration files may be generated from templates external to the image and are bound to the running container by the orchestrator, for example via environment variable injection or mounts (e.g., Kubernetes ConfigMap/Secret volumes). The external configuration files may reference (linked to) the container image by immutable digest and override defaults in the base manifest without modifying the image layer. Secrets (e.g., dynamic parameters or functions) are supplied at deployment time through a secret manager, and only opaque references to those secrets appear in the image. In other embodiments, the generated configuration files are baked into the container image as a layer, and a launcher reads them at startup.

During the packaging process, the system incorporates deployment-specific optimizations to enhance performance and reliability. For instance, the code is analyzed for redundancies, and unused functions or variables are removed to minimize the application's footprint. Additionally, logging and monitoring hooks may be embedded into the code to provide visibility into runtime behavior, which is particularly useful for debugging and performance tuning in production environments.

Finally, the packaged application is subjected to a series of validation checks to ensure deployment readiness. These checks include verifying the integrity of configuration files, testing the application in a simulated runtime environment, and ensuring compatibility with the target operating system or container orchestration platform. For example, in a dynamic network configuration use case for telecommunications, the system might simulate high-density user scenarios to validate the application's performance and resource utilization under realistic conditions.

The result of this process is a deployment-ready application package, such as a self-contained directory, a container image, or a cloud-native deployment manifest. This package can be deployed directly into production environments with minimal manual intervention, ensuring a smooth transition from design to operation.

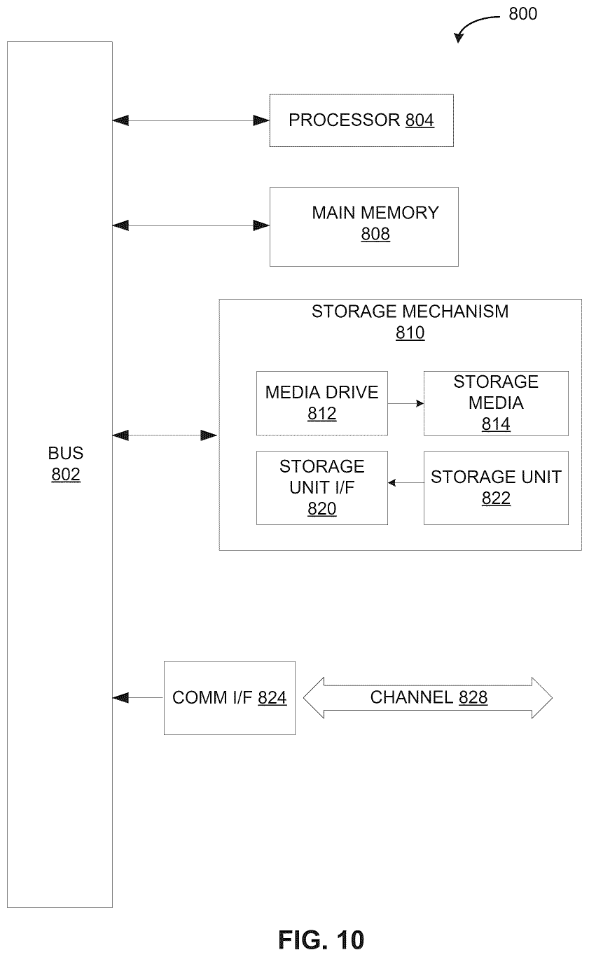

FIG. 10 illustrates an example computing system 800 that may be used in implementing various features of embodiments of the disclosed technology.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAS, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 10. Various embodiments are described in terms of this example-computing module 800. After reading this description, it will become apparent to a person skilled in the relevant art how to implement the application using other computing modules or architectures.

Referring now to FIG. 10, computing module 800 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display, input devices, or cursor control to help facilitate interaction and communications between the processor and/or other components of the computing module 800.

Computing module 800 might also include one or more memory modules, simply referred to herein as main memory 808. For example, preferably random-access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device 810 coupled to bus 802 for storing static information and instructions for processor 804.

Computing module 800 might also include one or more various forms of information storage devices 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD, DVD or Bluray drive (R or RW), or other removable or fixed media drive 812 might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit 822 and a storage unit interface 820. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface 824 or network interface(s). Communications or network interface(s) interface 824 might be used to allow software and data to be transferred between computing module 800 and external devices. Examples of communications interface or network interface(s) might include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel 828. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 808, ROM, and storage unit interface 820. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and FIGs are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method executed by one or more hardware processors and non-transitory memory for transforming a user-defined program flowchart into executable code for a target environment, the method comprising:
receiving, via a graphical authoring interface or an import interface, a representation of the flowchart and storing the flowchart as a typed graph of nodes and directed edges, at least a subset of the nodes being associated with a node description comprising a natural-language statement or pseudocode;
constructing a knowledge base of domain terms by ingesting, with authenticated access, user-authorized schemas, code repositories, and application programming interface (API) specifications;
for a node of the typed graph that includes a node description, identifying, from the knowledge base, one or more domain terms corresponding to the node description and context of the typed graph; and
generating machine-executable artifacts by:
lowering the typed graph and the identified one or more domain terms into a typed intermediate program representation that encodes control flow and data dependencies;
emitting executable code from the intermediate program representation, the executable code comprising parameterized data-access statements and API invocations resolved from the API specifications stored in the knowledge base; and
assembling a deployable runtime package comprising the emitted code together with a configuration file identifying dependencies and network endpoints for the target environment.

2. The method of claim 1, wherein the constructing the knowledge base of domain terms comprises:
in response to user-provided credentials, establishing authenticated connections to one or more sources selected from relational databases, the code repositories, and services that expose the API specifications, and retrieving domain elements by:
for each relational database, enumerating schemas, tables, columns, data types, constraints, or column descriptions and acronyms, to recognize relationships between fields;
for each code repository, parsing source files to identify functions, classes, variables, and module paths and to extract inline documentation; and
for each API description, parsing interface specifications to identify endpoint identifiers, parameters, and request/response field types;
normalizing the retrieved domain elements into data objects each having a canonical name, one or more aliases, a type descriptor including a data format, and associated metadata; and
indexing the data objects in a vector-embedding index, serving as the domain terms to support semantic retrieval during mapping.

3. The method of claim 1, wherein the identifying one or more domain terms corresponding to the node description of the node and context of the typed graph comprises:
generating, based on the context of the typed graph, graph features comprising one or more of node kind, branch polarity, loop depth, and port data-type annotations;
computing, by a visual encoder, a per-node embedding based on the graph features;
generating, by a natural language encoder, an embedding of the node description;
generating a fused embedding by combining the per-node embedding with the embedding of the node description; and
performing an embedding-based retrieval over the knowledge base based on the fused embedding to obtain at least one canonical domain term.

4. The method of claim 1, wherein the identifying one or more domain terms further comprises:
inferring, based on context of the typed graph, one or more constraints of the node and associated edges, wherein the one or more constraints comprise at least a node type and expected data types of adjacent ports; and
biasing the identifying of the one or more domain terms toward candidates whose declared types satisfy the one or more inferred constraints, thereby disfavoring candidates that are type-incompatible with the context of the typed graph.

5. The method of claim 1, further comprising:
executing the executable code in a sandboxed runtime; and
in response to detecting a runtime error, invoking a runtime error handler to modify the executable code by applying exception-specific correction rules prior to assembling or deploying the deployable runtime package.

6. The method of claim 1, wherein the target environment comprises a Radio Access Network (RAN) management environment and.
the assembling the deployable runtime package further comprises:
building a bundle deployable to a Service Management and Orchestration (SMO) platform and exposing health, metrics, or control endpoints.

7. The method of claim 1, wherein the generating the machine-executable artifacts further comprises:
automatically generating unit tests that simulate execution scenarios from the typed graph and the identified one or more domain terms, wherein the generating comprises, for each decision node represented in the flowchart, generating one or more tests that exercise alternative branches corresponding to different outcomes of the decision node;
executing the unit tests and recording results; and
in response to a modification of the flowchart, re-generating and re-running the unit tests.

8. The method of claim 7, wherein the automatically generated unit tests comprise tests that validate that parameters and data types used by the executable code are compatible with corresponding types declared in the knowledge base, and
wherein the deployment of the deployable runtime package is initiated after determining, from the recorded results, that the unit tests pass.

9. The method of claim 1, wherein the target environment comprises a Radio Access Network (RAN) management environment and, and the method further comprises:
ingesting performance-management data of the RAN, the performance-management data comprising at least one of physical resource block utilization, handover failure ratios, radio resource control setup success rates, or throughput distributions; and
executing the runtime package based on the performance-management data to detect network conditions comprising at least congestion, coverage or capacity imbalance, or energy-savings opportunities.

10. The method of claim 1, wherein the assembling the deployable runtime package comprises:
generating environment-specific configuration files declaring one or more of dependency versions, environment variables, logical secret references, health and readiness probes, and metrics endpoints;
building a container image that includes the emitted code;
associating the environment-specific configuration files with the container image; and
outputting the deployable runtime package comprising the container image and the environment-specific configuration files.

11. A system for transforming a user-defined program flowchart into executable code for a target environment, comprising:
one or more hardware processors; and
one or more non-transitory machine-readable storage media encoded with instructions that, when executed by the one or more hardware processors, cause the system to perform operations comprising:
receiving, via a graphical authoring interface or an import interface, a representation of the flowchart and storing the flowchart as a typed graph of nodes and directed edges, at least a subset of the nodes being associated with a node description comprising a natural-language statement or pseudocode;
constructing a knowledge base of domain terms by ingesting, with authenticated access, user-authorized schemas, code repositories, and application programming interface (API) specifications;
for a node of the typed graph that includes a node description, identifying, from the knowledge base, at least one domain term corresponding to the node description and context of the typed graph; and
generating machine-executable artifacts by:
lowering the typed graph and the identified one or more domain terms into a typed intermediate program representation that encodes control flow and data dependencies;
emitting executable code from the intermediate program representation, the executable code comprising parameterized data-access statements and API invocations resolved from the API specifications stored in the knowledge base; and
assembling a deployable runtime package comprising the emitted code together with a configuration file identifying dependencies and network endpoints for the target environment.

12. The system of claim 11, wherein the identifying one or more domain terms corresponding to the node description and context of the typed graph comprises:
generating, based on the context of the typed graph, graph features comprising one or more of node kind, branch polarity, loop depth, and port data-type annotations;
computing, by a visual encoder, a per-node embedding based on the graph features;
generating, by a natural language encoder, an embedding of the node description;
generating a fused embedding by combining the per-node embedding with the node-description embedding; and
performing an embedding-based retrieval over the knowledge base based on the fused embedding to obtain at least one canonical domain term.

13. The system of claim 11, wherein the identifying one or more domain terms further comprises:
inferring, based on context of the typed graph, one or more constraints of the node and associated edges, wherein the one or more constraints comprise at least a node type and expected data types of adjacent ports; and
biasing the identifying of the one or more domain terms toward candidates whose declared types satisfy the one or more inferred constraints, thereby disfavoring candidates that are type-incompatible with the context of the typed graph.

14. The system of claim 11, wherein the target environment comprises a Radio Access Network (RAN) management environment and.
the assembling the deployable runtime package further comprises:
building a bundle deployable to a Service Management and Orchestration (SMO) platform and exposing health, metrics, or control endpoints.

15. The system of claim 11, wherein the generating the machine-executable artifacts further comprises:
automatically generating unit tests that simulate execution scenarios from the typed graph and the identified one or more domain terms, wherein the generating comprises, for each decision node represented in the flowchart, generating one or more tests that exercise alternative branches corresponding to different outcomes of the decision node;
executing the unit tests and recording results; and
in response to a modification of the flowchart, re-generating and re-running the unit tests.

16. One or more non-transitory machine-readable storage media encoded with instructions that, when executed by one or more hardware processors of a computing system for transforming a user-defined program flowchart into executable code for a target environment, cause the computing system to perform operations comprising:
receiving, via a graphical authoring interface or an import interface, a representation of the flowchart and storing the flowchart as a typed graph of nodes and directed edges, at least a subset of the nodes being associated with a node description comprising a natural-language statement or pseudocode;
constructing a knowledge base of domain terms by ingesting, with authenticated access, user-authorized schemas, code repositories, and application programming interface (API) specifications;
for a node of the typed graph that includes a node description, identifying, from the knowledge base, one or more domain terms corresponding to the node description and context of the typed graph; and
generating machine-executable artifacts by:
lowering the typed graph and the identified one or more domain terms into a typed intermediate program representation that encodes control flow and data dependencies;
emitting executable code from the intermediate program representation, the executable code comprising parameterized data-access statements and API invocations resolved from the API specifications stored in the knowledge base; and
assembling a deployable runtime package comprising the emitted code together with a configuration file identifying dependencies and network endpoints for the target environment.

17. The non-transitory machine-readable storage media of claim 16, wherein the constructing the knowledge base of domain terms comprises:
in response to user-provided credentials, establishing authenticated connections to one or more sources selected from relational databases, the code repositories, and services that expose the API specifications, and retrieving domain elements by:
for each relational database, enumerating schemas, tables, columns, data types, constraints, or column descriptions and acronyms, to recognize relationships between fields;
for each code repository, parsing source files to identify functions, classes, variables, and module paths and to extract inline documentation; and
for each API description, parsing interface specifications to identify endpoint identifiers, parameters, and request/response field types;
normalizing the retrieved domain elements into data objects each having a canonical name, one or more aliases, a type descriptor including a data format, and associated metadata; and
indexing the data objects in a vector-embedding index, serving as the domain terms to support semantic retrieval during mapping.

18. The non-transitory machine-readable storage media of claim 16, wherein the identifying one or more domain terms corresponding to the node description and context of the typed graph comprises:
generating, based on the context of the typed graph, graph features comprising one or more of node kind, branch polarity, loop depth, and port data-type annotations;
computing, by a visual encoder, a per-node embedding based on the graph features;
generating, by a natural language encoder, an embedding of the node description;
generating a fused embedding by combining the per-node embedding with the embedding of the node description; and
performing an embedding-based retrieval over the knowledge base based on the fused embedding to obtain at least one canonical domain term.

19. The non-transitory machine-readable storage media of claim 16, wherein the generating the machine-executable artifacts further comprises:
automatically generating unit tests that simulate execution scenarios from the typed graph and the one or more domain terms, wherein the generating comprises, for each decision node represented in the flowchart, generating one or more tests that exercise alternative branches corresponding to different outcomes of the decision node;
executing the unit tests and recording results; and
in response to a modification of the flowchart, re-generating and re-running the unit tests.

20. The non-transitory machine-readable storage media of claim 16, wherein the target environment comprises a Radio Access Network (RAN) management environment, and the operations further comprise:
ingesting performance-management data of the RAN, the performance-management data comprising at least one of physical resource block utilization, handover failure ratios, radio resource control setup success rates, or throughput distributions; and
executing the runtime package based on the performance-management data to detect network conditions comprising at least congestion, coverage or capacity imbalance, or energy-savings opportunities.
